(19) United States
(12) Patent Application Publication
(10) Pub. No.: US 2016/0295267 A1
(43) Pub. Date: Oct. 6, 2016

(54) DATA RESOURCE TRANSMISSION METHOD AND DEVICE

(71) Applicant: LE SHI ZHI XIN ELECTRONIC TECHNOLOGY (TIANJIN) LIMITED, Beijing (CN)

(72) Inventors: Hailong HU, Beijing (CN); Xie CHEN, Beijing (CN); Fan LIANG, Beijing (CN); Zhen LI, Beijing (CN)

(21) Appl. No.: 15/036,726

(22) PCT Filed: Nov. 12, 2014
(86) PCT No.: PCT/CN2014/090917

§ 371 Date: May 13, 2016

(30) Foreign Application Priority Data
Nov. 14, 2013 (CN) 201310563877.7
Nov. 14, 2013 (CN) 201310563878.1
Nov. 14, 2013 (CN) 201310564276.8
Nov. 14, 2013 (CN) 201310564277.2

(51) Int. Cl. H04N 21/41; H04N 21/436; H04N 21/414

(52) U.S. Cl. CPC H04N 21/4108; H04N 21/41407; H04N 21/43615

(57) ABSTRACT

A data resource transmission method and a device are disclosed. The method includes: obtaining IP address of smart TV, and generating and sending first control instruction carrying the IP address to the smart TV; or generating second control instruction to control the mobile terminal to log in to preset server; when detecting a first preset touch operation, displaying a data resource stored locally, and when detecting a data resource triggering operation, generating and sending a third control instruction to the smart TV, or sending the third control instruction to the server and the server sending the third control instruction to the smart TV; or when detecting a second preset touch operation, displaying a first network browser, and when detecting a network data resource triggering operation, obtaining storage address of triggered network data resource; generating and sending fourth control instruction, or sending the fourth control instruction to the server.

The present disclosure is a national stage of International Application No. PCT/CN2014/090917 filed Nov. 12, 2014, which claims priority from Chinese Patent Application No. 201310563878.1, titled “DATA RESOURCE TRANSMISSION METHOD AND DEVICE”, Chinese Patent Application No. 201310563877.7, titled “NETWORK DATA RESOURCE TRANSMISSION METHOD AND DEVICE”, Chinese Patent Application No. 201310564277.2, titled “NETWORK DATA RESOURCE TRANSMISSION METHOD AND DEVICE”, Chinese Patent Application No. 201310564276.8, titled “DATA RESOURCE TRANSMISSION METHOD AND DEVICE”, all of which are filed on Nov. 14, 2013 in the Chinese Intellectual Property Office, the contents of which in its entirety are herein incorporated by reference.

### FIELD OF TECHNOLOGY

The present disclosure relates to the technical field of an automatic control, more specifically to transmission methods and devices of data resource.

### BACKGROUND

Mobile terminals such as mobile phones and pads play a more and more important role in daily life of people, and are necessary living and entertainment tools of people.

Various types of data resource stored in the mobile terminals. When needed, corresponding data resource are acquired from the mobile terminals, for example, the mobile terminals output local videos or audios, locally stored pictures, etc.

To achieve a better display effect, it is expected that smart TVs output the local data resource stored on the mobile terminals or network data resource. Therefore, pushing the local data resource stored on the mobile terminals or network data resource to the smart TVs to be output is an urgent needs.

### SUMMARY

For this reason, the present disclosure discloses data resource transmission method and device to meet peoples' needs of pushing the local data resource stored on the mobile terminals or network data resource to the smart TVs to be output.

In order to solve one of the objectives, the present disclosure discloses technical solutions as below.

A data resource transmission method, applied to a mobile terminal, the method including:

acquiring an IP address of a smart TV, generating and sending a first command with the IP address of the smart TV to the smart TV, wherein the first control command controls the mobile terminal and the smart TV to access a same local area network; or generating a second control command to control the mobile terminal to log into a preset server;

when detecting a first preset touch operation of a user, displaying locally stored data resource;

when detecting the user's operation of triggering the data resource, generating and sending a third command, which carries the triggered data resource and is configured to control the smart TV to output the triggered data resource, to the smart TV, or sending the third control command to the server such that the server sends the third control command to the smart TV which logs into the same server together with the mobile terminal;

or,

when detecting a second preset touch operation of the user, displaying a first network browser;

when detecting the operation that the user triggers the network data resource, acquiring the storage address of the triggered network data resource;

generating and sending a fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal.

In a specific embodiment of the present disclosure, before generating and sending a third command, which carries the triggered data resource and is configured to control the smart TV to output the triggered data resource, to the smart TV, or before sending the third control command to the server such that the server sends the third control command to the smart TV which logs into the same server together with the mobile terminal, the method further including:

determining the sequence of outputting the triggered data resource;

generating sequence mark and putting the sequence mark in the triggered data resource;

generating user's third preset touch operation;

before generating and sending the fourth control command, which carries the storage address of the network data resource and is configured to control the smart TV to call the second network browser to output the network data resource according to the storage address of the network data resource, to the smart TV, or before sending the fourth control command to the server such that the server sends the fourth control command to the smart TV that logs in the same server together with the mobile terminal, the method further including:

determining the sequence of outputting the triggered network data resource;

generating sequence mark and putting the sequence mark in the storage address of the triggered data resource;

detecting user's fourth preset touch operation;

generating and sending a third command, which carries the triggered data resource and is used to control the smart TV to play the triggered data resource, to the smart TV, or sending the third control command to the server such that the server sends the third control command to the smart TV which logs into the same server together with the mobile terminal, is specifically as follows:

generating and sending a third command, which carries the data resource with the sequence mark and is configured to control the smart TV to output the triggered data resource in turn according to the sequence mark, to the smart TV, or sending the third control command to the server such that the server sends the third control command to the smart TV which logs into the same server together with the mobile terminal;

generating and sending the fourth control command, which carries the storage address of the network data resource and is configured to control the smart TV to call the second network browser to output the network data resource according to the storage address of the network data resource, to the smart TV, or sending the fourth control command to the server such that the server sends the fourth control command to the smart TV that logs in the same server together with the mobile terminal, is specifically as follows:

generating and sending a fourth control command, which carries the storage address of the network data resource with the sequence mark and is configured to control the smart TV to call the second network browser to output the triggered network data resource according to the sequence mark and the storage address of the triggered network data resource, to the smart TV, or sending the fourth control command to the server such that the server sends the fourth control command to the smart TV that logs in the same server together with the mobile terminal.

In a specific embodiment of the present disclosure, before generating and sending a third command, which carries the triggered data resource and is configured to control the smart TV to output the triggered data resource, to the smart TV, or before sending the third control command to the server such that the server sends the third control command to the smart TV which logs into the same server together with the mobile terminal, also including:

determining the type of the triggered data resource;

when determining that the triggered data resource is a video resource or an audio resource, acquiring the path of the triggered resource;

generating and sending a fifth control command, which carries the path of the triggered data resource, to the smart TV, or sending the fifth control command to the server such that the server sends the fifth control command to the smart TV which logs into the same sever together with the mobile terminal, and the fifth control command is configured to turn on the player of the smart TV;

receiving a play request sent by the smart TV after turning on the player or receiving the play request sent by the smart TV after turning on the player through the server.

In a specific embodiment of the present disclosure, after generating and sending a third command, which carries the triggered data resource and is configured to control the smart TV to output the triggered data resource, to the smart TV, or after sending the third control command to the server such that the server sends the third control command to the smart TV which logs into the same server together with the mobile terminal, the method further including:

when detecting that the user triggers the preset operation for controlling the play status, generating and sending a sixth control command corresponding to a preset operation which controls the player generation of the smart TV and the play status to the smart TV, or sending the sixth control command to the server such that the server sends the sixth control command to the smart TV which logs into the same server together with the mobile terminal.

when the triggered network data resource are network video resource or network audio resource, after generating and sending a fourth control command, which carries the storage address of the triggered network data resource and is configured to control the smart TV to call the second network browser to output the triggered network data resource according to the storage address of the triggered network data resource, to the smart TV, or after sending the fourth control command to the server such that the server sends the fourth control command to the smart TV that logs in the same server together with the mobile terminal, the method further including:

when detecting that the user triggers the preset operation for controlling the play status on the first network browser, generating and sending a seventh control command corresponding to a preset operation which controls the generation of the second network browser of the smart TV and the play status to the smart TV.

The present disclosure further discloses a data resource transmission method, applied to a smart TV, the method including:

receiving a third control command or a fourth control command sent by the mobile terminal, wherein the third control command or the fourth control command is the first control command; the mobile terminal acquires the IP address of the smart TV, generates and sends the first control command, which carries the acquired the IP address of the smart TV to the smart TV; the first control command controls the mobile terminal and the smart TV to access the same local area network;

displaying locally stored data resource when detecting the user's first preset touch operation, and generating the a control command, which carries the triggered data resource and is configured to control the smart TV to output the triggered data resource when detecting the user's operation of triggering the data resource;

when detecting the user's second preset touch operation, displaying the first network browser; when detecting the user's operation of triggering the network data resource, acquiring the storage address of the triggered network data resource, generating the third control command, which carries the storage address of the triggered network data resource and is configured to control the smart TV to call the second network browser to output the triggered network data resource according to the storage address of the triggered network data resource; resolving the third control command, outputting the triggered network data resource; or resolving the fourth control command, and calling the second network browser to output the triggered network data resource according to the storage address of the triggered network data resource.

In a specific embodiment of the present disclosure, the third control command sent by the mobile terminal is the control command that is generated by the mobile terminal, carries the data resource with the sequence mark and is configured to control the smart TV to output the triggered data resource in turn according to the sequence mark; wherein, the sequence mark are sequence mark that are generated by the mobile terminals when determining the output sequence of the triggered data resource and carried in the triggered data resource;

outputting the data resource specifically is:

outputting the triggered data resource in turn according to the sequence mark;

receiving the fourth control command sent by the mobile terminal is as follows: the mobile terminal generates the control command, which carries the storage address of the network data resource with sequence mark, is configured to control the smart TV to call the second network browser to output the triggered network data resource in turn according to the sequence mark and storage address of the triggered network data resource; wherein the sequence mark are sequence mark that are generated by the mobile terminals when determining the output sequence of the triggered network data resource and carried in the storage address of the triggered network data resource;

resolving the fourth control command and calling the second network browser to output the triggered network data resource according to the storage address of the triggered network data resource is specifically as follows:

resolving the fourth control command and calling the second network browser to output the triggered network data resource according to the sequence mark and the storage address of the triggered network data resource.

In a specific embodiment of the present disclosure, before receiving the second control command sent by the mobile terminal, also including:

receiving a fifth control command sent by the mobile terminal, wherein, the fifth control command is a control command generated in the following conditions: the mobile terminal determines the type of the triggered data; when determining that the triggered data resource are video resource or audio resource, the mobile terminal acquires the paths of the triggered data resource, and generates the fifth control command which carries the paths of the triggered data resource and is configured to turn on the player of the smart TV.

turning on the player of the smart TV according to the fifth control command; and,

sending a play request to the mobile terminal.

In a specific embodiment of the present disclosure, after resolving the second control command and outputting the triggered data resource, also including:

receiving a sixth control command sent by the mobile terminal, wherein, the sixth control command is a control command corresponding to the preset operation for controlling the generation of player of the smart TV and the play status, generated when the user detects the user's preset operation for controlling the play status;

controlling the player of the smart TV to generate the corresponding play status according to the sixth control command;

after resolving the fourth control command and calling the second network browser to output the network data resource according to the storage address of the triggered network data resource, also including:

receiving a seventh control command sent by the mobile terminal, wherein, the seventh control command is a control command generated to control the second network browser of the smart TV to generate the preset operation corresponding to the play status when the mobile terminal detects that the user triggers the preset operation, which controls the play status, on the first network browser; and

controlling the second network browser of the smart TV to generate the corresponding play status according to the seventh control command.

The present disclosure further discloses a data resource transmission method, characterized by being applied to a smart TV, the method including:

generating an eighth control command to control the mobile terminal to log into a preset server;

receiving the third control command or fourth control command sent by the server, wherein the third control command is a control command generated under the following conditions; the mobile terminal generates the second control command to control the mobile terminal the log into the preset server; when detecting the user's first preset touch operation, the mobile terminal displays locally stored data resource; when detecting the user's operation of triggering the data resource, the mobile terminal generates the control command, which carries the triggered data resource and is configured to control the smart TV to output the triggered data resource, and sends the third control command to the server; wherein, the fourth control command is a control command generated in the following conditions: the mobile terminal generates the first control command to control the mobile terminal to log into the preset server; when detecting the second preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server;

resolving the third control command and outputting the triggered data resource; resolving the fourth control command and calling the second network browser to output the triggered network data resource according to the storage address of the triggered network data resource.

In a specific embodiment of the present disclosure, the step of receiving the third control command sent by the server is as follows: the mobile terminal generates a third control command, which carries the data resource with the sequence mark and is configured to control the smart TV to output the triggered data resource in turn according to the sequence mark, and sends the control command to the server; wherein, the sequence mark are generated when the mobile terminal determines the output sequence of the triggered data resource, and carried in the triggered data resource;

receiving the fourth control command sent by the server is as follows: the mobile terminal generates the control command, which carries the storage address of the network data resource with sequence mark and is configured to control the smart TV to call the second network browser to output the triggered network data resource in turn according to the sequence mark and storage address of the triggered network data resource, and sends the fourth control command to the server; wherein the sequence mark are generated when the mobile terminal determines the output sequence of the triggered network data resource, and carried in the storage address of the triggered network data resource;

outputting the triggered data resource is specifically:

outputting the triggered data resource in turn according to the sequence mark;

resolving the fourth control command and calling the second network browser to output the triggered network data resource according to the storage address of the triggered network data resource is specifically as follows:

resolving the second control command and calling the second network browser to output the triggered network data resource according to the sequence mark and the storage address of the triggered network data resource.

In a specific embodiment of the present disclosure, before receiving the third or fourth control command sent by the server, also including:

receiving a fifth control command sent by the server; wherein, the fifth control command is a control command generated in the following conditions: the mobile terminal determines the type of the triggered data resource; when determining that the triggered data resource are video resource or audio resource, the mobile terminal acquires the paths of the triggered data resource, generates the fifth control command, which carries the paths of the triggered data resource and is configured to turn on the player of the smart TV, and sends the fifth control command to the server;

turning on the player of the smart TV according to the fifth control command; and,

sending a play request to the server, wherein the server sends the play request to the mobile terminal.

In a specific embodiment of the present disclosure, after resolving the third control command and outputting the triggered data resource, also including:

receiving a sixth control command sent by the server, wherein, the sixth control command is a control command generated when the mobile terminal detects that the user triggers the preset operation for controlling the play status; and the sixth control command is a control command corresponding to the preset operation for controlling the generation of the player of the smart TV and play status, and is sent to the server;

controlling the player of the smart TV to generate the corresponding play status according to the sixth control command;

after resolving the fourth control command and calling the second network browser to output the network data resource according to the storage address of the triggered network data resource, also including:

receiving a seventh control command sent by the server, wherein, the seventh control command is a control command generated under the following conditions: when detecting that the user triggers the preset operation, which controls the play status, on the first network browser, the mobile terminal generates the seventh control command corresponding to the preset operation which controls the generation of the second browser of the smart TV and the play status, and sends the seventh control command to the server;

controlling the second network browser of the smart TV to generate the corresponding play status according to the seventh control command.

The present disclosure further discloses a data resource transmission device, characterized by being applied to a mobile terminal, the device including:

a first generating and sending module, configured to acquire an IP address of a smart TV, generate and send a first command with the IP address of the smart TV to the smart TV, wherein the first control command controls the mobile terminal and the smart TV to access the same local area network; or generate a second control command to control the mobile terminal to log into a preset server;

a detection and display module, configured to display locally stored data resource when detecting the user's preset touch operation, or display the a first network browser when detecting the user's second preset touch operation, and acquire the storage address of the triggered network data resource when detecting the user's operation of triggering the network data resource;

a second generating and sending module configured to, when detecting the user's operation of triggering the data resource, generate and send the third control command, which carries the triggered data resource and is configured to control the smart TV to output the triggered data resource, to the smart TV, or send the third control command to the server such that the server sends the third control command to the smart TV that logs in the same server together with the mobile terminal; or the second generating and sending module configured to, when detecting the user's operation of triggering the network data resource, generate and send the fourth control command, which carries the storage address of the triggered network data resource and is configured to control the smart TV to call the second network browser to output the triggered network data resource according to the storage address of the triggered network data resource, to the smart TV, or send the fourth control command to the server such that the server sends the fourth control command to the smart TV that logs in the same server together with the mobile terminal.

In a specific embodiment of the present disclosure, the device also including:

the sequence determining module, configured to verify the output sequence of the triggered data resource or the triggered network data resource;

a generation module, configured to generate the sequence mark and put the sequence mark in the triggered data resource or storage address of the network data resource;

a first detection module, configured to detect a third or fourth preset touch operation of a user;

the second generating and sending module is specifically configured to, after the first detection module detects the user's second preset touch operation, generate and send the third control command, which carries the triggered data resource and is configured to control the smart TV to output the triggered data resource, to the smart TV, or send the third control command to the server such that the server sends the third control command to the smart TV that logs in the same server together with the mobile terminal; or the second generating and sending module is configured to generate and send the fourth control command, which carries the storage address of the triggered network data resource and is configured to control the smart TV to call the second network browser to output the triggered network data resource according to the sequence mark and the storage address of the triggered network data resource, to the smart TV, or send the fourth control command to the server such that the server sends the fourth control command to the smart TV that logs in the same server together with the mobile terminal.

In a specific embodiment of the present disclosure, the device also including:

a type determining module, configured to verify the type of outputting the triggered data resource;

the path acquiring module, configured to acquire the paths of the triggered data resource when the type determining module determines the triggered data resource are video resource or audio resource;

a third generating and sending module, configured to generate and send the fifth control command which carries the path of the triggered data resource, to the smart TV, or send the fifth control command to the server to send the fifth control command, by the server, to the smart TV that logs in the same sever together with the mobile terminal, wherein the fifth control command is configured to turn on the player of the smart TV;

a first receiving module, configured to receive a play request, or through the server, receive the play request sent by the smart TV after the smart TV turning on the player;

the second generating and sending module is specifically configured to generate and send the second control command that carries the triggered data resource and configured set to control the smart TV to output the triggered data resource to the smart TV when the first detection module receives the play request after the smart TV turns on the player.

In a specific embodiment of the present disclosure, the device also including:

a fourth generating and sending module, configured to, when defecting the user's preset operation of triggering the play status, generate and send the sixth control command corresponding to the preset operation for controlling the generation of the player of the smart TV and the play status to the smart TV or send the sixth control command to the smart TV through the server; or configured to, when detecting the user triggers the preset operation, which controls on the play status, on the first network browser, generate and send the seven control command corresponding to the preset operation which controls the generation and play status of the second browser of the smart TV, to the smart TV, or send the seventh control command to the smart TV through the server.

The present disclosure further discloses a data resource transmission device, characterized by being applied to a smart TV, the device including:

a second receiving module, configured to receive the third control command or fourth control command sent by the mobile terminal, wherein the third control command or fourth control command is generated under the following conditions: the mobile terminal acquires the IP address of the smart TV, generates and sends the first control command with the IP address of the smart TV to the smart TV; the first control command controls the mobile terminal and the smart TV to access the same local area network; when detecting the user's first preset touch operation, the mobile terminal displays the locally stored data resource; when detecting the user's operation of triggering the data resource, the mobile terminal generates a control command which carries the triggered data resource and is configured to control the smart TV to output the triggered data resource; when detecting the user's second preset touch operation, the mobile terminal displays the first network browser; when detecting the user's operation of triggering network data resource, the mobile terminal acquires storage address of the triggered network data resource, and generates a control command that carries the storage address of the triggered network data resource, is configured to control the smart TV to call the second network browser to output the triggered network data resource according to the storage address of the triggered network data resource;

a first resolving and output module, configured to resolve the third control command and output the triggered data resource, or resolve the fourth control command and call the second network browser to output the triggered network data resource according to the storage address of the triggered network data resource.

In a specific embodiment of the present disclosure, the second receiving module receives the third control command sent by the mobile terminal in this way: the mobile terminal generates a control command that carries the data resource with the sequence mark and is configured to control the smart TV to output the triggered data resource in turn according to the sequence mark; wherein, the sequence mark are generated when the mobile terminal determines the output sequence of the triggered data resource and are carried in the triggered data resource;

the second receiving module receives the fourth control command sent by the mobile terminal in the following way: the mobile terminal generates a control command which carries the storage address of the network data resource with sequence mark and is configured to control the smart TV to call the second network browser to output the triggered network data resource in turn according to the sequence mark and storage address of the triggered network data resource; wherein the sequence mark are generated when the mobile terminal determines the output sequence of the triggered network data resource and are carried in the storage address of the triggered network data resource; the first resolving output module is specifically configured to output the triggered data resource in turn according to the sequence mark;

the first resolving and output module is also specifically configured to call the second network browser to output the triggered network data resource in turn according to the sequence mark and storage address of the triggered network data resource.

In a specific embodiment of the present disclosure, the device also including:

a third receiving module, configured to receive a fifth control command sent by the mobile terminal; wherein, the fifth control command is a control command generated in the following conditions: the mobile terminal determines the type of the triggered data; when determining that the triggered data resource are video resource or audio resource, the mobile terminal acquires the paths of the triggered data resource, and generates the fifth control command which carries the paths of the triggered data resource and is configured to turn on the player of the smart TV;

a first opening module, configured to turn on the player of the smart TV according to the fifth control command;

a first sending module, configured to send the play request to the mobile terminal; and,

a second receiving module, configured to receive third control command sent by the mobile terminal after the first sending module sends the play request to the mobile terminal.

In a specific embodiment of the present disclosure, the device also including:

a fourth receiving module, configured to receive the sixth control command sent by the mobile terminal after the resolving and output module resolves the third control command and outputs the triggered data resource, or receive the seventh control command sent by the mobile terminal after the resolving and output module resolves the fourth control command and outputs the triggered network data resource;

wherein, the sixth control command is a control command generated under the following conditions: when detecting that user triggers the preset operation for controlling the play status, the mobile terminal generates the sixth control command corresponding to the preset operation for controlling the player generation and play status of the smart TV;

wherein, the seventh control command is a control command generated under the following conditions: when detecting that the user triggers the preset operation, which controls the play status, on the first network browser, the mobile terminal generates the seventh control command corresponding to the preset operation which controls the generation of the second browser of the smart TV and the play status;

the first control module, configured to control the second network browser of the smart TV to generate the corresponding play status according to the sixth control status, or control the second network browser of the smart TV to generate corresponding play status according to the seventh control command.

The present disclosure further discloses a data resource transmission device, characterized by being applied to a smart TV, the device including:

a fifth generating and sending module, configured to generate an eighth control command to control the smart TV to log in a preset server;

the fifth receiving module, configured to receive the third control command or fourth control command sent by the server, wherein the third control command is a control command generated under the following conditions; the mobile terminal generates the second control command to control the mobile terminal the log into the preset server; when detecting the user's first preset touch operation, the mobile terminal displays locally stored data resource; when detecting the user's operation of triggering the data resource, the mobile terminal generates the control command, which carries the triggered data resource and is configured to control the smart TV to output the triggered data resource, and sends the third control command to the server; wherein, the fourth control command is a control command generated in the following conditions: the mobile terminal generates the first control command to control the mobile terminal to log into the preset server; when detecting the second preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server; and,

a second resolving and output module, configured to resolve the third control command and output the triggered data resource, or resolve the fourth control command and call the second network browser to output the triggered network data resource according to the storage address of the triggered network data resource.

In a specific embodiment of the present disclosure, the fifth receiving module receives the third control command sent by the server in the following way: the mobile terminal generates a third control command, which carries the data resource with the sequence mark and is configured to control the smart TV to output the triggered data resource in turn according to the sequence mark, and sends the control command to the server; wherein, the sequence mark are generated when the mobile terminal determines the output sequence of the triggered data resource, and are carried in the triggered data resource;

the fifth receiving model receives the fourth control command sent by the server in the following way: the mobile terminal generates the control command, which carries the storage address of the network data resource with sequence mark and is configured to control the smart TV to call the second network browser to output the triggered network data resource in turn according to the sequence mark and storage address of the triggered network data resource, and sends the fourth control command to the server; wherein the sequence mark are generated when the mobile terminal determines the output sequence of the triggered network data resource, and are carried in the storage address of the triggered network data resource;

the second resolving and output module specifically outputs the triggered data resource in the following way:

outputting the triggered data resource in turn according to the sequence mark;

the second resolving and output module resolves the fourth control command and calls the second network browser to output the triggered network data resource according to the storage address of the triggered network data resource specifically in the following way:

resolving the second control command and calling the second network browser to output the triggered network data resource according to the sequence mark and the storage address of the triggered network data resource.

In a specific embodiment of the present disclosure, the device also including:

a sixth receiving module, configured to receive the fifth control command sent by the server; wherein, the fifth control command is a control command generated in the following conditions: the mobile terminal determines the type of the triggered data resource; when determining that the triggered data resource are video resource or audio resource, the mobile terminal acquires the paths of the triggered data resource, generates the fifth control command, which carries the paths of the triggered data resource and is configured to turn on the player of the smart TV, and sends the fifth control command to the server;

a second opening module, configured to turn on the player of the smart TV according to the fifth control command;

a second sending module, configured to send the play request to the server, wherein the server sends the play request to the mobile terminal.

In a specific embodiment of the present disclosure, the device also including:

a seventh receiving module, configured to receive the sixth control command send by the server and receive the seventh control command sent by the server; wherein, the sixth control command is a control command generated when the mobile terminal detects that the user triggers the preset operation for controlling the play status; and the sixth control command is a control command corresponding to the preset operation for controlling the generation of the player of the smart TV and play status, and is sent to the server; wherein, the seventh control command is a control command generated under the following conditions: when detecting that the user triggers the preset operation, which controls the play status, on the first network browser, the mobile terminal generates the seventh control command corresponding to the preset operation which controls the generation of the second browser of the smart TV and the play status, and sends the seventh control command to the server;

a second control module, configured to control the second network browser of the smart TV to generate the corresponding play status according to the sixth control status, or control the second network browser of the smart TV to generate corresponding play status according to the seventh control command.

The present disclosure further discloses a mobile terminal for data resource transmission, including:

at least one first processor;
a first memory for storing at least one instruction executable by the first processor;
wherein the first processor is configured to perform:
acquiring an IP address of a smart TV, generating and send a first command with the IP address of the smart TV to the smart TV, wherein the first control command controls the mobile terminal and the smart TV to access the same local area network; or generate a second control command to control the mobile terminal to log into a preset server;
displaying locally stored data resource when detecting the user's preset touch operation, or displaying the a first network browser when detecting the user's second preset touch operation, and acquire the storage address of the triggered network data resource when detecting the user's operation of triggering the network data resource;
when detecting the user's operation of triggering the data resource, generating and send the third control command, which carries the triggered data resource and is configured to control the smart TV to output the triggered data resource, to the smart TV, or send the third control command to the server such that the server sends the third control command to the smart TV that logs in the same server together with the mobile terminal; or when detecting the user's operation of triggering the network data resource, generating and send the fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal.

The present disclosure further discloses a smart TV for data resource transmission, the smart TV including:

at least one second processor;

a second memory for storing at least one instruction executable by the second processor;
wherein the second processor is configured to perform:
receiving the third control command or fourth control command sent by the mobile terminal, wherein the third control command or fourth control command is generated under the following conditions: the mobile terminal acquires the IP address of the smart TV, generates and sends the first control command with the IP address of the smart TV to the smart TV; the first control command controls the mobile terminal and the smart TV to access the same local area network; when detecting the user's first preset touch operation, the mobile terminal displays the locally stored data resource; when detecting the user's operation of triggering the data resource, the mobile terminal generates a control command which carries the triggered data resource and is configured to control the smart TV to output the triggered data resource; when detecting the user's second preset touch operation, the mobile terminal displays the first network browser; when detecting the user's operation of triggering network data resource, the mobile terminal acquires storage address of the triggered network data resource, and generates a control command that carries the storage address of the triggered network data resource, is configured to control the smart TV to call the second network browser to output the triggered network data resource according to the storage address of the triggered network data resource;
resolving the third control command and outputting the triggered data resource, or resolving the fourth control command and calling the second network browser to output the triggered network data resource according to the storage address of the triggered network data resource.

The present disclosure further discloses a smart TV for data resource transmission, the smart TV including:

a third memory for storing at least one instruction executable by the third processor;

wherein the third processor is configured to perform:

generating an eighth control command to control the smart TV to log in a preset server;

receiving the third control command or fourth control command sent by the server, wherein the third control command is a control command generated under the following conditions: the mobile terminal generates the second control command to control the mobile terminal the log into the preset server; when detecting the user's first preset touch operation, the mobile terminal displays locally stored data resource; when detecting the user's operation of triggering the data resource, the mobile terminal generates the control command, which carries the triggered data resource and is configured to control the smart TV to output the triggered data resource, and sends the third control command to the server; wherein, the fourth control command is a control command generated in the following conditions: the mobile terminal generates the first control command to control the mobile terminal to log into the preset server; when detecting the second preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server; and,

resolving the third control command and output the triggered data resource, or resolving the fourth control command and calling the second network browser to output the triggered network data resource according to the storage address of the triggered network data resource.

The present disclosure further discloses a non-transitory computer readable recording medium having computer programs stored thereon that, when executed by one or more processors of a mobile terminal, cause the mobile terminal to perform:

acquiring an IP address of a smart TV, generating and sending a first command with the IP address of the smart TV to the smart TV, wherein the first control command controls the mobile terminal and the smart TV to access the same local area network; or generating a second control command to control the mobile terminal to log into a preset server;

when detecting a first preset touch operation of a user, displaying locally stored data resource;

when detecting the user's operation of triggering the data resource, generating and sending a third command, which carries the triggered data resource and is configured to control the smart TV to output the triggered data resource, to the smart TV, or sending the third control command to the server such that the server sends the third control command to the smart TV which logs into the same server together with the mobile terminal;

or,

when detecting a second preset touch operation of the user, displaying a first network browser;

when detecting the operation that the user triggers the network data resource, acquiring a storage address of the triggered network data resource;

generating and sending a fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal.

According to the above technical solution, the present disclosure, set as smart TV, is able to output the triggered local data resource or network data resource, fulfilling the aim of outputting the local data resource stored on the mobile terminals or network data resource from the smart TV, and meeting people's needs of pushing the local data resource stored on the mobile terminals or network data resource to the smart TVs to be output.

### BRIEF DESCRIPTION OF THE DRAWINGS

In order to more clearly understand above objects, features and advantages of the disclosure, hereinafter the disclosure will be further described in detail in conjunction with accompanying drawings and specific implementations. Obviously, the drawings described hereinafter are only embodiments of the present disclosure, a skilled person in the art may obtain other drawings according to the provided drawings without creativity.

FIG. 1 is a flowchart of a data resource transmission method according to an embodiment of the present disclosure.

FIG. 2 is a flowchart of a data resource transmission method according to an embodiment of the present disclosure.

FIG. 3 is a flowchart of a data resource transmission method according to an embodiment of the present disclosure.

FIG. 4 is a flowchart of another data resource transmission method according to an embodiment of the present disclosure.

FIG. 5 is a flowchart of another data resource transmission method according to an embodiment of the present disclosure.

FIG. 6 is a flowchart of a data resource transmission method according to an embodiment of the present disclosure.

FIG. 7 is a flowchart of a data resource transmission method according to an embodiment of the present disclosure.

FIG. 8 is a flowchart of a data resource transmission method according to an embodiment of the present disclosure.

FIG. 9 is a flowchart of another data resource transmission method according to an embodiment of the present disclosure.

FIG. 10 is a flowchart of another data resource transmission method according to an embodiment of the present disclosure.

FIG. 11 is a flowchart of a network data resource transmission method according to an embodiment of the present disclosure.

FIG. 12 is a flowchart of a network data resource transmission method according to an embodiment of the present disclosure.

FIG. 13 is a flowchart of another network data resource transmission method according to an embodiment of the present disclosure.

FIG. 14 is a flowchart of another network data resource transmission method according to an embodiment of the present disclosure.

FIG. 15 is a flowchart of a network data resource transmission method according to an embodiment of the present disclosure.

FIG. 16 is a flowchart of a network data resource transmission method according to an embodiment of the present disclosure.

FIG. 17 is a flowchart of another network data resource transmission method according to an embodiment of the present disclosure.

FIG. 18 is a flowchart of another network data resource transmission method according to an embodiment of the present disclosure.

FIG. 19 is a structural view of a data resource transmission device according to an embodiment of the present disclosure.

FIG. 20 is a structural view of a data resource transmission device according to an embodiment of the present disclosure.

FIG. 21 is a structural view of a data resource transmission device according to an embodiment of the present disclosure.

FIG. 22 is a structural view of another data resource transmission device according to an embodiment of the present disclosure.

FIG. 23 is a structural view of another data resource transmission device according to an embodiment of the present disclosure.

FIG. 24 is a structural view of a data resource transmission device according to an embodiment of the present disclosure.

FIG. 25 is a structural view of a data resource transmission device according to an embodiment of the present disclosure.

FIG. 26 is a structural view of a data resource transmission device according to an embodiment of the present disclosure.

FIG. 27 is a structural view of another data resource transmission device according to an embodiment of the present disclosure.

FIG. 28 is a structural view of another data resource transmission device according to an embodiment of the present disclosure.

FIG. 29 is a structural view of a transmission device of a type of network data resource according to an embodiment of the present disclosure.

FIG. 30 is a structural view of a transmission device of a type of network data resource according to an embodiment of the present disclosure.

FIG. 31 is a structural view of a transmission device of another type of network data resource according to an embodiment of the present disclosure.

FIG. 32 is a structural view of a transmission device of another type of network data resource according to an embodiment of the present disclosure.

FIG. 33 is a structural view of a transmission device of a type of network data resource according to an embodiment of the present disclosure.

FIG. 34 is a structural view of a transmission device of a type of network data resource according to an embodiment of the present disclosure.

FIG. 35 is a structural view of a transmission device of another type of network data resource according to an embodiment of the present disclosure.

FIG. 36 is a structural view of a transmission device of another type of network data resource according to an embodiment of the present disclosure.

### DESCRIPTION OF THE EMBODIMENTS

One embodiment of the present disclosure discloses a data resource transmission method. The method can be applied to a mobile terminal. The mobile terminal may be a mobile phone, a pad and any other hand-held device.

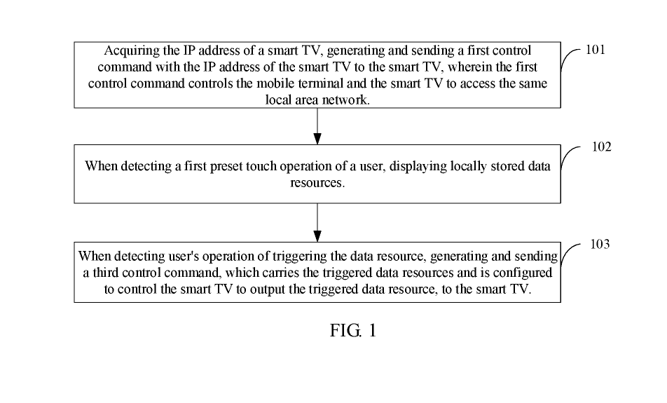

See FIG. 1 for details. The method includes the following steps.

Step 101: Acquiring the IP address of a smart TV, generating and sending a first command with the IP address of the smart TV to the smart TV, wherein the first control command controls the mobile terminal and the smart TV to access the same local area network.

When the mobile terminal and the smart TV locate in the same local area network, the mobile terminal can acquire the IP address of the smart TV by searching the network; the mobile terminal is required to access the same local area network together with the smart TV, namely, generating and sending the first control command with the IP address of smart TV, to the smart TV, to control the mobile terminal and the smart TV to access the same local area network, thus establishing connection.

Optionally, the first control command can control the mobile terminal and the smart TV to establish WIFI connection.

Wherein, when plural smart TVs exist in the local area network, the mobile terminal can acquire the IP address of a certain smart TV, and together with the specific smart TV, access the same local area network through the first control command to establish connection.

Step 102: When detecting a first preset touch operation of a user, displaying locally stored data resource.

Wherein, the mobile terminal is provided with a first preset touch operation, and the first touch operation is an operation for triggering the mobile terminal to display the locally stored data resource.

Specifically, the form of the first preset touch operation may be set upon actual situations. For example, the mobile terminal is provided with a corresponding touch key, while the first preset touch operation may be set as an operation which is triggered by touching the key; when the user triggers the touch key, the mobile terminal can detect the first preset touch operation of the user, and then the mobile terminal displays the locally stored data resource. Of course, the first preset touch operation may also be an operation triggered by shaking the mobile terminal; when the user shakes the mobile terminal once (the specific shaking times can be set according to the actual situations), the mobile terminal can detect the first preset touch operation of the user, and then the mobile terminal displays the locally stored data resource.

It is understandable that, the data resource locally stored in the mobile terminal may be video resource, audio resource, picture resources, etc.

Step 103: When detecting user's operation of triggering the data resource, generating and sending a third control command, which carries the triggered data resource and is configured to control the smart TV to output the triggered data resource, to the smart TV.

Wherein, the mobile terminal displays the locally stored data resource; when the user triggers a certain data resource, the mobile terminal can detect the triggering operation of the user; then, the mobile terminal can generate the third control command which carries the triggered data resource and is configured to control the smart TV to output the triggered data resource, and send the third control command to the smart TV. Specifically, when the triggered data resource is picture resource, the smart TV can display the corresponding data resource; when the triggered data resource is video resource or audio resource, the smart TV can display the video sources or audio sources through a corresponding player.

In this embodiment, the local data resource stored in the mobile terminal can be output on the smart TV, meeting people's needs of pushing the local data resource stored on the mobile terminals or network data resource to the smart TV to be output.

As another embodiment, in the present disclosure, the mobile terminal can also locally output the triggered data resource. Specifically, different from the above embodiment, when the mobile terminal detects the user's operation of triggering the data resource, the following is also included:

locally outputting the triggered data resource.

In such case, the triggered data resource is output not only on the smart TV, but also on the mobile terminal.

It is required to be noted that, the operation that the mobile terminal locally outputs the triggered data resource and the operation that the mobile terminal generates and sends the third control command, which carries the triggered data resource and is configured to control the smart TV to output the data resource, to the smart TV, are executed without limit in sequence; the mobile terminal can locally output the triggered data resource first and then generate and send the third command third control command, which carries the triggered data resource and is configured to control the smart TV to output the data resource, to the smart TV; the mobile terminal can also generate and send the third command, which carries the triggered data resource and is configured to control the smart TV to output the data resource, to the smart TV first, and then locally output the triggered data resource. Of course, the mobile terminal can also locally output the triggered data resource while generate and send the third command third control command, which carries the triggered data resource and is configured to control the smart TV to output the data resource, to the smart TV, and then the triggered data resource will be output on the mobile terminal and the on the smart TV at the same time.

In this embodiment, the triggered data resource can output not only on the mobile terminal, but also on the smart TV, so people can watch the data resource on different devices, meeting the expanded needs of people.

As another embodiment, in the present disclosure, different from the above embodiment, the mobile terminal can generate and send the third control command, which carries the triggered data resource and is configured to controlling the smart TV to output the triggered data resource, to the smart TV after detecting the third preset touch operation of the user.

Wherein, the third preset touch operation is an operation for triggering the mobile terminal to generate and send the third control command. In such case, the mobile terminal does not generate and send the third control command, which carries the triggered data resource and is configured to controlling the smart TV to output the triggered data resource, to the smart TV if not detecting the third preset touch operation of the user.

Specifically, the form of the third preset touch operation may be set upon actual situations. For example, the mobile terminal is provided with a send key, while the third preset touch operation may be set as an operation which is triggered by touching the send key; when the user triggers the send key, the mobile terminal can detect the third preset touch operation of the user, and then the mobile terminal generates and sends the third control command. Of course, the third preset touch operation may also be an operation triggered by shaking the mobile terminal; when the user shakes the mobile terminal once (the specific shaking times can be set according to the actual situations), the mobile terminal can detect the third preset touch operation of the user, and then the mobile terminal generates and sends the third control command.

It is understandable that, by setting the third preset touch operation in the mobile terminal, the user can click a plurality of data resource and then trigger the third preset touch operation such that the mobile terminal can generate and send the third control command with the plurality of triggered data resource, and the third control command can control the smart TV to output the plurality of data resource in turn.

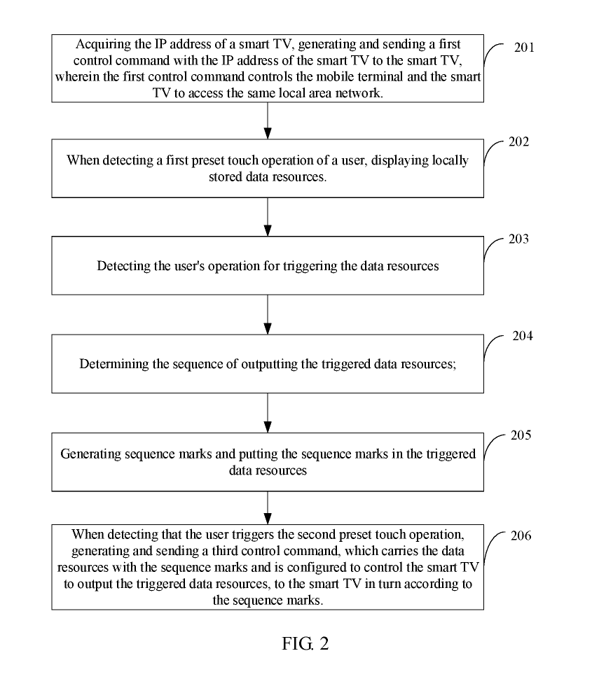

In order to control the sequence of the triggered data resource output on the smart TV, this embodiment of this present disclosure also discloses a data resource transmission method. As shown in FIG. 2, the method includes:

Step 201: Acquiring the IP address of a smart TV, generating and sending a first command with the IP address of the smart TV to the smart TV, wherein the first control command controls the mobile terminal and the smart TV to access the same local area network.

Step 202: When detecting a first preset touch operation of a user, displaying locally stored data resource.

Step 203: Detecting the user's operation for triggering the data resource.

Step 204: determining the sequence of outputting the triggered data resource.

When a plurality of data resource is triggered, the mobile terminal can verify the output sequence of the plurality of data resource such that the smart TV can output the plurality of triggered data resource according to the output sequence.

Wherein, a plurality of modes can be used to verify the output sequence of the triggered data resource; as a determining mode, the mobile terminal detects the sequence that the plurality of data resource is triggered, and defines the detected sequence as the corresponding output sequence, namely the first triggered data resource is output to the smart TV first, while the last triggered data resource is output to the smart TV at last.

Of course, other determining modes are available. As another determining mode, the mobile terminal can detect the capacities of the plurality of triggered data resource, and define the rank of the detected capacities as the corresponding output sequence. For example, the data resource with the biggest capacities are output on the smart TV first, while the data resource with the smallest capacities is output on the smart TV at last.

It is required to be noted that, the specific determining mode can be set according to the actual situations and is not limited to the above two modes. For example, the user can rank the plurality of triggered data resource upon personal needs, and the mobile terminal detects the ranking sequence of the plurality of triggered data resource and determines the sequence of the triggered data resource according to the sequence.

Step S205: Generating sequence mark and putting the sequence mark in the triggered data resource.

After the mobile terminal determines the output sequence of the plurality of triggered data resource, the plurality of the triggered data resource can be allocated with corresponding sequence mark, and the sequence mark is the mark for distinguishing the output sequence of the triggered data resource.

Step 206: When detecting that the user triggers the third preset touch operation, generating and sending a third control command that carries the data resource with the sequence mark and is configured to control the smart TV to output the triggered data resource in turn according to the sequence mark, to the smart TV.

In this embodiment, the mobile terminal can control the smart TV to output the triggered data resource in turn according to the corresponding sequence, improving the flexibility of the data resource output.

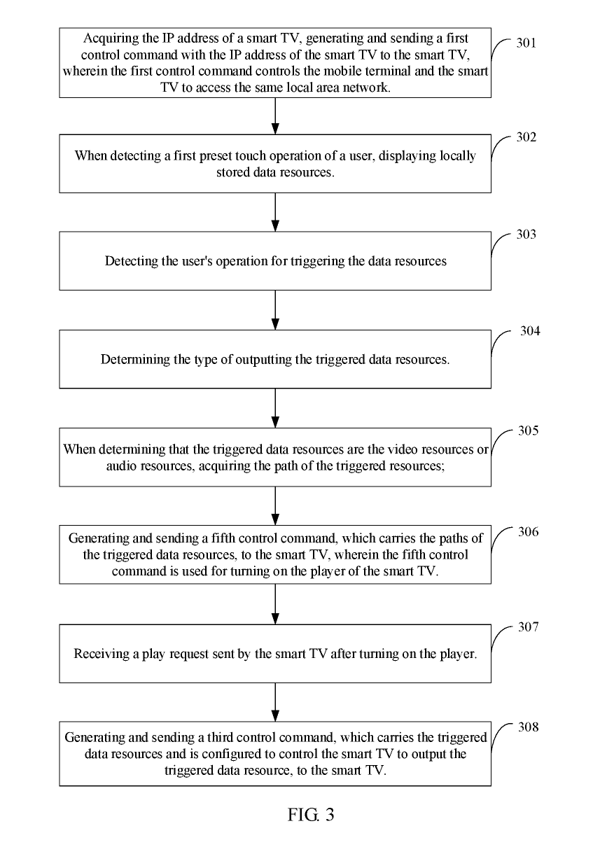

An embodiment of the present disclosure also discloses a data resource transmission method. The method can be applied to a mobile terminal. As shown in FIG. 3, the method includes the following steps.

Step 301: Acquiring the IP address of a smart TV, generating and sending a first command with the IP address of the smart TV to the smart TV, wherein the first control command controls the mobile terminal and the smart TV to access the same local area network.

Step 302: When detecting a first preset touch operation of a user, displaying locally stored data resource.

Step 303: Detecting the user's operation for triggering the data resource.

Step 304: Determining the type of outputting the triggered data resource.

Various types of data resource are stored in the mobile terminal, including video resource, audio resource, picture resources, etc.; the mobile terminal can verify the data resource type that the triggered data resource belong.

Wherein, according to the description in the above embodiment, the mobile terminal can also verify the type of the triggered data resource after detecting that the user triggers the second preset touch operation.

Step 305: When determining that the data resource is the video resource or audio resource, acquiring the path of the triggered resource.

The path of the data resource refers to the location of the data resource stored in the mobile terminal.

Wherein, different data resources are stored at different locations in the mobile terminal. For example, some data resources are stored in the memory of the mobile terminal, and some stored in the storage card of the mobile terminal; of course, some data resources may also be located in different folders.

Step 306: Generating and sending a fifth control command, which carries the paths of the triggered data resource, to the smart TV, wherein the fifth control command is used for turning on the player of the smart TV.

When the mobile terminal acquires the paths of the triggered data resource, the path of the data resource can be put in the fifth control command and send to the smart TV, and the fifth control command can control the player of the smart TV to turn on.

Wherein, the player of the smart TV refers to a player that can play video resource or audio resource.

Step 307: Receiving a play request sent by the smart TV after turning on the player.

When the third control command controls the player of the smart TV to turn on, the smart TV sends the request for playing the video resource or audio resource to the mobile terminal.

Step 308: Generating and sending a third control command, which carries the triggered data resource and is configured to control the smart TV to output the triggered data resource, to the smart TV.

When the mobile terminal receives the play request, the triggered video resource or audio resource is put in the third control command and sent to the smart TV such that the player of the smart TV can play the corresponding video resource or audio resource.

It is required to be noted that, in this embodiment, when receiving the display request sent by the smart TV after the smart TV turns on player, or when detecting that the user triggers the third preset touch operation, the mobile terminal can generate and send the third control command, which carries the triggered data resource and is configured to control the smart TV to output the triggered data resource, to the smart TV.

After the mobile terminal generates and sends the third control command, which carries the triggered data resource and is configured to control the smart TV to output the triggered data resource, to the smart TV, the method also includes:

generating and sending a sixth control command corresponding to a preset operation which controls the generation of the player of the smart TV and the play status to the smart TV when the user triggers the preset operation for controlling the play status.

Wherein, the preset operation for controlling the play status can be configured as triggering the player for controlling the smart TV to generate the operation corresponding to the preset operation of the play status.

When the triggered data resource is video resource or audio resource and is played on the player of the smart TV, the mobile terminal can control the play status in which the smart TV plays the video resource or the audio resource by setting the preset operation for controlling the play status. Various preset operations for controlling the play status are available, for example: fast forward, backward, close, etc., which can be specifically reflected by setting the corresponding touch key on the mobile terminal.

For example, when the mobile terminal detects that the user triggers the preset operation for controlling the play status to pause, the mobile terminal generates and sends the sixth control command for controlling the player of the smart TV to be in the fast forward play status to the smart TV, so the smart TV controls the player to stop playing the triggered data resource according to the sixth control command.

In actual application, the mobile terminal can generate and send the third control command, which carries the triggered data resource and is configured to control the smart TV to output the data resource, to the smart TV, while play the triggered video resource or audio resource through the local player. Specifically, the local player of the mobile terminal is equipped with various touch keys for control over the play status, and when detecting that the user triggers the preset operation for controlling the play status on the local player, the mobile terminal can generate and transmit the sixth control command corresponding to the preset operation for controlling the player generation and play status of the smart TV to the smart TV.

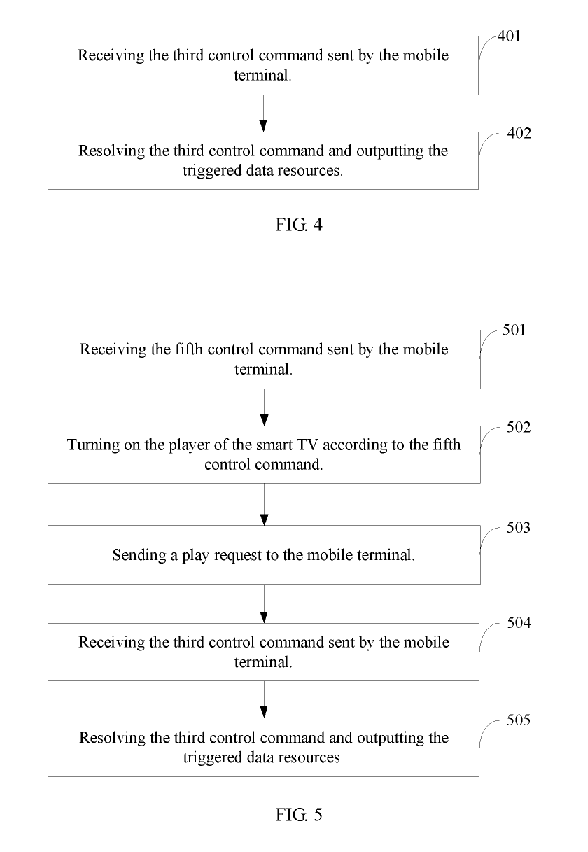

An embodiment of the present disclosure also discloses a data resource transmission method. The method can be applied to a mobile terminal. As shown in FIG. 4, the method includes:

Step 401: Receiving the third control command sent by the mobile terminal.

Wherein, the third control command is a control command generated in the following conditions: the mobile terminal acquires the IP address of a smart TV, generates and sends the first control command with the IP address of the smart TV to the smart TV; the first control command controls the mobile terminal and the smart TV to access the same local area network; when detecting the first preset touch operation of the user, the mobile terminal displays the locally stored data resource; when detecting the user's operation of the triggering the data resource, the mobile terminal generates the third control command, which carries the triggered data resource and is configured to control the smart TV to output the triggered data resource.

Step 402: Resolving the third control command and outputting the triggered data resource.

Wherein, by resolving the second control command, the smart TV can acquire the triggered data resource carried by the second control command, and the smart TV can output the triggered data resource.

In this embodiment, the smart TV can output the triggered data resource according to the second control command sent by the mobile terminal, meeting people's needs of pushing the local data resource stored on the mobile terminals or network data resource to the smart TV to be output.

As another embodiment of the present disclosure, the step that the smart TV receives the third control command sent by the mobile terminal is as follow: when the mobile terminal generates the control command, which carries the data resource with the sequence mark and is configured to control the smart TV to output the triggered data resource in turn according to the sequence mark, the smart TV resolves the third control command and outputs the triggered data resource in turn according to the sequence mark.

Wherein, the sequence mark is sequence mark generated by the mobile terminals when determining the output sequence of the triggered data resource and put in the triggered data resource.

In this embodiment, the smart TV outputs the triggered data resource in turn according to the corresponding sequence mark, improving the flexibility of the data resource output.

An embodiment of the present disclosure also discloses another data resource transmission method. The method can be applied to a smart TV. As shown in FIG. 5, the method includes:

Step 501: Receiving the fifth control command sent by the mobile terminal.

Wherein, the fifth control command is a control command generated in the following conditions: the mobile terminal determines the type of the triggered data; when determining that the triggered data resource is video resource or audio resource, the mobile terminal acquires the paths of the triggered data resource, and generates the fifth control command which carries the paths of the triggered data resource and is configured to turn on the player of the smart TV.

Step 502: Turning on the player of the smart TV according to the fifth control command.

Wherein, the player of the smart TV can play video resource or audio resource.

Step 503: Sending the play request to the mobile terminal.

When turning on the player, the smart TV sends the request for playing the triggered video resource or audio resource to the mobile terminal.

Step 504: Receiving the third control command sent by the mobile terminal.

Wherein, the third control command is a control command, which carries the triggered data resource and is configured to control the smart TV to output the triggered data resource.

Step 505: Resolving the third control command and outputting the triggered data resource.

The smart TV acquires the triggered data resource after resolving the third control command, and the triggered data resource is video resource or audio resource, so the smart TV uses the enabled player to play the triggered data resource.

Wherein, after the smart TV resolves the third control command and outputs the triggered data resource, the method may also include:

Receiving the sixth control command sent by the mobile terminal.

Wherein, the sixth control command is a control command corresponding to the preset operation for controlling the generation of the player of the smart TV and play status, generated when the user triggers the preset operation for controlling the play status.

Controlling the player of the smart TV to generate the corresponding play status according to the sixth control command.

It is understandable that, when the smart TV outputs the triggered data resource, the play status, e.g. fast forward, backward, close, can be controlled by the mobile terminal.

Another embodiment of the present disclosure discloses a data resource transmission method. The method can be applied to a mobile terminal. The mobile terminal may be a mobile phone, a pad and any other hand-held device.

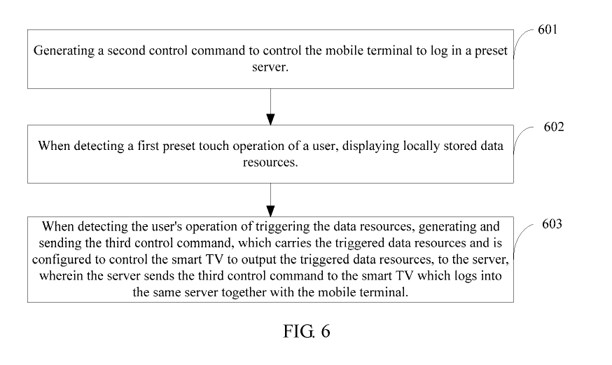

See FIG. 6 for details. The method may include the following steps.

Step 601: Generating a second control command to control the mobile terminal to log into a preset server.

When the mobile terminal and the smart TV are in different local area networks, it is required to move the mobile terminal and the smart TV to log into the same server.

Specifically, the user can perform login by entering an account number and password on the mobile terminal; of course, setting a password is not necessary, the login is performed by only entering the account number of the server into the mobile terminal; when the user triggers the login button, the mobile terminal generates the second control command to control the mobile terminal to log into the preset server corresponding to the account number.

Step 602: When detecting a first preset touch operation of a user, displaying locally stored data resource.

Wherein, the mobile terminal is provided with a first preset touch operation, and the first touch operation is an operation for triggering the mobile terminal to display the locally stored data resource.

Specifically, the form of the first preset touch operation may be set upon actual situations. For example, the mobile terminal is provided with a corresponding touch key, while the first preset touch operation may be set as an operation which is triggered by touching the key; when the user triggers the touch key, the mobile terminal can detect the first preset touch operation of the user, and then the mobile terminal displays the locally stored data resource. Of course, the first preset touch operation may also be an operation triggered by shaking the mobile terminal; when the user shakes the mobile terminal once (the specific shaking times can be set according to the actual situations), the mobile terminal can detect the first preset touch operation of the user, and then the mobile terminal displays the locally stored data resource.

It is understandable that, the data resource locally stored in the mobile terminal may be video resource, audio resource, picture resources, etc.

Step 603: When detecting the user's operation of triggering the data resource, generating and sending the second command, which carries the triggered data resource and is configured to control the smart TV to output the triggered data resource, to the server, wherein the server transmits the third control command to the smart TV which logs into the same server together with the mobile terminal.

Wherein, only when the smart TV and the mobile terminal log into the same server can the smart TV receive the third control command sent by the server.

If several smart TVs log into the same server together with the mobile terminal, the mobile terminal can select a specific smart TV; the mobile terminal sends the third control command to the server; then, the server sends the third control command to the specific smart TV. Of course, the server can sends the third control command to one of the several smart TVs logging in the same server together with the mobile terminal.

Wherein, the mobile terminal displays the locally stored data resource; when the user triggers certain data resource, the mobile terminal may detect the triggering operation of the user; then, the mobile terminal can generate the third control command, which carries the triggered data resource and is configured to control the smart TV to output the triggered data resource, and send the third control command to the smart TV. Specifically, when the triggered data resource is picture resource, the smart TV can display the corresponding data resource; when the triggered data resource is video resource or audio resource, the smart TV can display the video sources or audio sources by using a corresponding player.

In this embodiment, the local data resource stored in the mobile terminal can be output on the smart TV, meeting people's needs of pushing the local data resource stored on the mobile terminals or network data resource to the smart TV to be output.

As another embodiment, in the present disclosure, the mobile terminal can also locally output the triggered data resource. Specifically, different from the above embodiment, when the mobile terminal detects the user's operation of triggering the data resource, the following is also included:

locally outputting the triggered data resource.

In such case, the triggered data resource is output not only on the smart TV, but also on the mobile terminal.

It is required to be noted that, the operation that the mobile terminal locally outputs the triggered data resource and the operation that the mobile terminal generates and sends the third control command, which carries the triggered data resource and is configured to control the smart TV to output the data resource, to the server are executed without limit in the sequence; the mobile terminal can locally output the triggered data resource first and then generate and send the third command, which carries the triggered data resource and is configured to control the smart TV to output the data resource, to the server; the mobile terminal can also generate and send the third control command, which carries the triggered data resource and is configured to control the smart TV to output the data resource, to the server first and then locally outputting the triggered data resource. Of course, the mobile terminal can also locally output the triggered data resource while generate and send the third command, which carries the triggered data resource and is configured to control the smart TV to output the data resource, to the server, and then the triggered data resource will be output on the mobile terminal and the on the smart TV at the same time.

In this embodiment, the triggered data resource can be output not only on the mobile terminal, but also on the smart TV, so more options are provided for selection, meeting the expanded needs of people.

As another embodiment, in the present disclosure, after detecting the user's third preset touch operation, the mobile terminal can generate and send the third command, which carries the triggered data resource and is configured to control the smart TV to output the triggered data resource, to the server, and then the server sends the third control command to the smart TV which logs in into the same server together with the mobile terminal.

Wherein, the third preset touch operation is an operation for triggering the mobile terminal to generate and send the third control command. In such case, the mobile terminal does not generate and send the third control command, which carries the triggered data resource and is configured to controlling the smart TV to output the triggered data resource to the smart TV if not detecting the third preset touch operation of the user.

Specifically, the form of the third preset touch operation can be set upon actual situations. For example, the mobile terminal is provided with a send key, while the third preset touch operation may be set as an operation which is triggered by touching the send key; when the user triggers the send key, the mobile terminal can detect the third preset touch operation of the user, and then the mobile terminal generates and sends the third control command. Of course, the third preset touch operation may also be an operation triggered by shaking the mobile terminal; when the user shakes the mobile terminal once (the specific shaking times can be set according to the actual situations), the mobile terminal can detect the third preset touch operation of the user, and then the mobile terminal generates and sends the third control command.

It is understandable that, by setting the third preset touch operation in the mobile terminal, the user can click a plurality of data resource and then trigger the third preset touch operation such that the mobile terminal can generate and send the third control command with the plurality of triggered data resource, and the third control command can control the smart TV to output the plurality of data resource in turn.

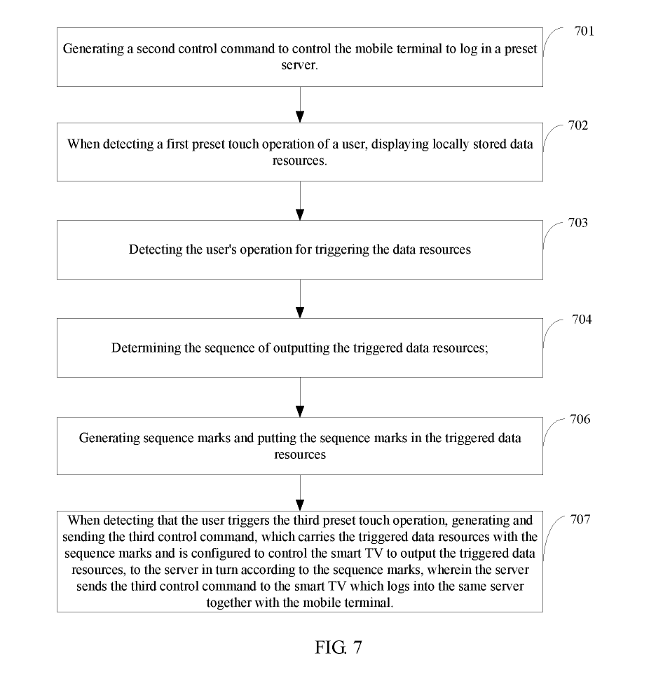

In order to control the sequence of the triggered data resource output on the smart TV, this embodiment of this present disclosure also discloses a data resource transmission method. As shown in FIG. 7, the method includes:

Step 701: Generating a second control command to control the mobile terminal to log into a preset server.

Step 702: When detecting a first preset touch operation of a user, displaying locally stored data resource.

Step 703: Detecting the user's operation for triggering the data resource.

Step 704: Determining the sequence of outputting the triggered data resource.

When a plurality of data resource is triggered, the mobile terminal can verify the output sequence of the plurality of data resource such that the smart TV can output the plurality of triggered data resource according to the output sequence.

Wherein, a plurality of modes can be used to verify the output sequence of the triggered data resource; as a determining mode, the mobile terminal detects the sequence that the plurality of data resource is triggered, and defines the detected sequence as the corresponding output sequence, namely the first triggered data resource is output to the smart TV first, while the last triggered data resource is output to the smart TV at last.

Of course, other determining modes are available. As another determining mode, the mobile terminal can detect the capacities of the plurality of triggered data resource, and define the rank of the detected capacities as the corresponding output sequence. For example, the data resource with the biggest capacities are output on the smart TV first, while the data resource with the smallest capacities are output on the smart TV at last.

It is required to be noted that, the specific determining mode can be set according to the actual situations and is not limited to the above two modes. For example, the user can rank the plurality of triggered data resource upon personal needs, and the mobile terminal detects the ranking sequence of the plurality of triggered data resource and determines the sequence of the triggered data resource according to the sequence.

Step 705: Generating sequence mark and putting the sequence mark in the triggered data resource.

After the mobile terminal determines the output sequence of the plurality of triggered data resource, the plurality of the triggered data resource can be allocated with corresponding sequence mark, and the sequence mark are the marks for distinguishing the output sequence of the triggered data resource.

Step 706: When detecting that the user triggers the third preset touch operation, generating and sending the third command, which carries the triggered data resource with the sequence mark and is configured to control the smart TV to output the triggered data resource, to the server in turn according to the sequence mark, wherein the server sends the third control command to the smart TV which logs in into the same server together with the mobile terminal.

In this embodiment, the mobile terminal can control the smart TV to output the triggered data resource in turn according to the corresponding sequence, improving the flexibility of the data resource output.

An embodiment of the present disclosure also discloses a data resource transmission method. The method can be applied to a mobile terminal. As shown in FIG. 8, the method includes:

Step 801: Generating a second control command to control the mobile terminal to log into a preset server.

Step 802: When detecting a first preset touch operation of a user, displaying locally stored data resource.

Step 803: Detecting the user's operation for triggering the data resource.

Step 804: Determining the type of outputting the triggered data resource.

Various types of data resource are stored in the mobile terminal, including video resource, audio resource, picture resources, etc.; the mobile terminal can verify the data resource type that the triggered data resource belong.

Wherein, according to the description in the above embodiment, the mobile terminal can also verify the type of the triggered data resource after detecting that the user triggers the second preset touch operation.

Step 805: When determining that the data resource is the video resource or audio resource, acquiring the path of the triggered resource.

The path of the data resource refers to the location of the data resource stored in the mobile terminal.

Wherein, different data resources are stored at different locations in the mobile terminal. For example, some data resources are stored in the memory of the mobile terminal, and some stored in the storage card of the mobile terminal; of course, some data resources may also be located in different folders.

Step 806: Generating and sending a fifth control command, which carries the paths of the triggered data resource, to the server, wherein the server sends the fifth control command to the smart TV which logs into the same sever together with the mobile terminal, and the fifth control command is configured to turn on the player of the smart TV.

When the mobile terminal acquires the paths of the triggered data resource, the path of the data resource can be put in the fifth control command and send to the smart TV; then, the server sends the fifth control command to the smart TV which logs into the same server together with the mobile terminal; and the fifth control command can control the player of the smart TV to turn on.

Wherein, the player of the smart TV refers to a player that can play video resource or audio resource.

Step 807: Receiving a play request sent by the server, wherein, the play request is a play request sent to the server after the smart TV logging in the same server together with the mobile terminal turns on the player.

When the fifth control command controls the player of the smart TV to turn on, the smart TV sends the request for playing the video resource or audio resource to the server, and the server sends the play request to the mobile terminal.

Step 808: Generating and sending the third command, which carries the triggered data resource and is configured to control the smart TV to output the triggered data resource, to the server, wherein the server sends the third control command to the smart TV which logs into the same server together with the mobile terminal.

When the mobile terminal receives the play request, the triggered video resource or audio resource is put in the third control command and sent to the server; then, the server sends the third command to the smart TV which logs into the same server together with the mobile terminal such that the player of the smart TV can play the corresponding video resource or audio resource.

It is required to be noted that, in this embodiment, after receiving the play request from the server, the mobile terminal can generate and send the third command, which carries the triggered data resource and is configured to control the smart TV to output the triggered data resource, to the server after detecting that the user triggers the second preset touch operation, and then the server sends the third control command to the smart TV which logs into the same server together with the mobile terminal.

Wherein, after the mobile terminal generates and sends the third command, which carries the triggered data resource and is configured to control the smart TV to output the triggered data resource, to the server, and the server sends the third control command to the smart TV which logs into the same server together with the mobile terminal, the method also includes:

when detecting the user triggers the preset operation for controlling the play status, generating and sending a sixth control command corresponding to a preset operation which controls the player generation of the smart TV and the play status to the server, wherein the server sends the sixth control command to the smart TV which logs into the same server together with the mobile terminal.

Wherein, the preset operation for controlling the play status can be configured as triggering the player for controlling the smart TV to generate the operation corresponding to the preset operation of the play status.

When the triggered data resource is video resource or audio resource and are played on the player of the smart TV, the mobile terminal can control the play status in which the smart TV plays the video resource or the audio resource by setting the preset operation for controlling the play status. Various preset operations for controlling the play status are available, for example: fast forward, backward, close, etc., which can be specifically reflected by setting the corresponding touch key on the mobile terminal.

For example, when the mobile terminal detects that the user triggers the preset operation for controlling the play status to pause, the mobile terminal generates and transmits the sixth control command for controlling the player of the smart TV to be in the fast forward play status to the sever, and then the server transmits the sixth control command to the smart TV that logs in the same server together with the mobile phone such that the smart TV controls the player to stop playing the triggered data resource according to the sixth control command.

In actual application, when the mobile terminal can generate and send the third control command, which carries the triggered data resource and is configured to control the smart TV to output the data resource, to the server, while play the triggered video resource or audio resource through the local player. Specifically, the local player of the mobile terminal is equipped with various touch keys for control over the play status, and the mobile terminal can generate and send the sixth control command corresponding to the preset operation for controlling the player generation and play status of the smart TV to the sever when detecting that the user triggers the preset operation for controlling the play status on the local player.

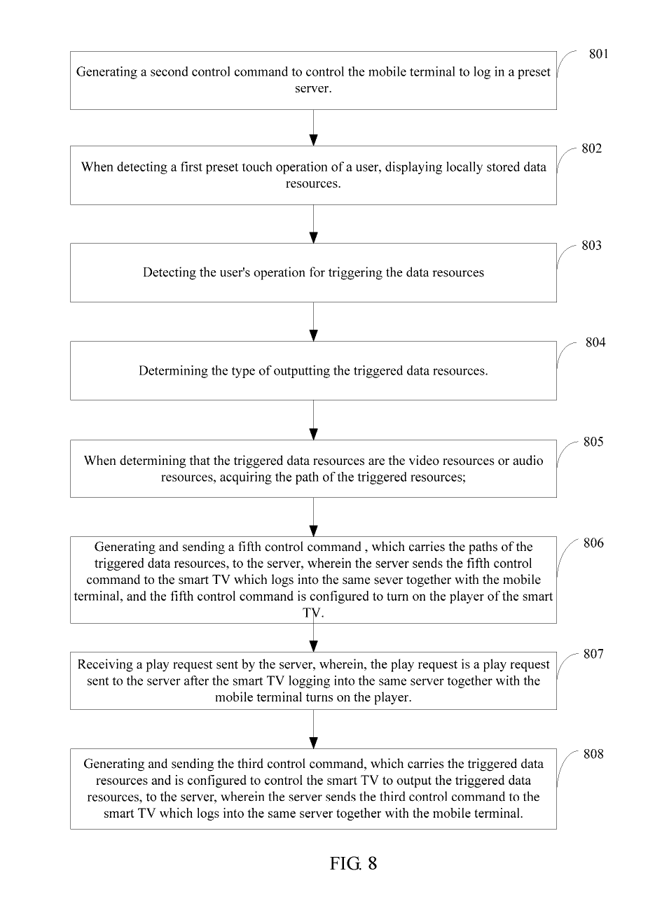

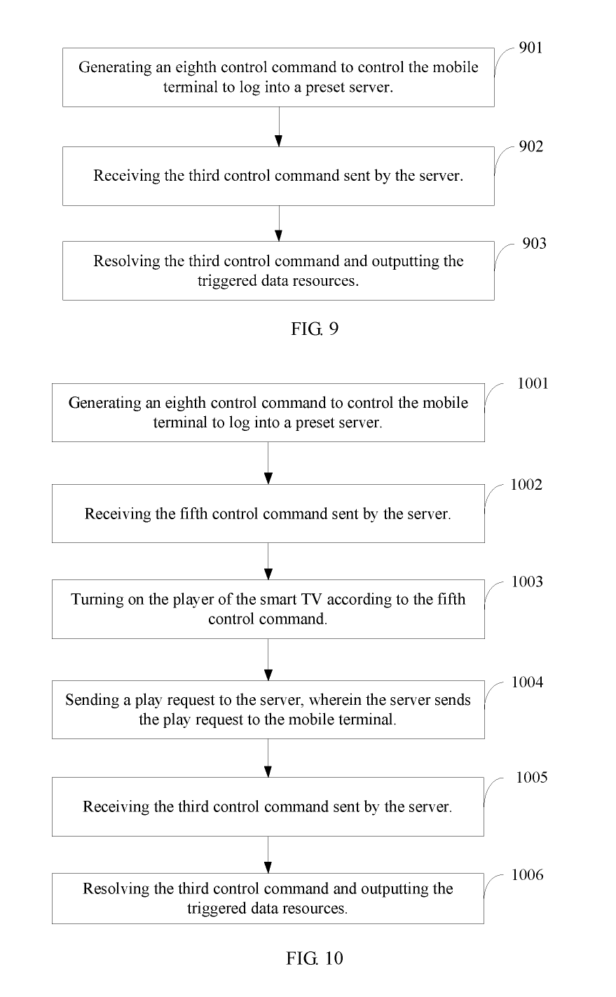

An embodiment of the present disclosure also discloses a data resource transmission method. The method can be applied to a smart TV. As shown in FIG. 9, the method may include:

Step 901: Generating an eighth control command to control the smart TV to log into a preset server.

When the data resource in the above mobile terminal is required to be output via the smart TV, the smart TV and the mobile terminal log into the same server, and the user can perform login by entering an account number and password on the mobile terminal; of course, setting a password is not necessary, the login is performed by only entering the account number of the server into the smart TV; when the user triggers the login button, the smart TV generates the fifth control command to control the smart TV to log into the preset server corresponding to the account number.

Step 902: Receiving the third control command sent by the server, wherein the third control command is a control command generated in the following conditions: the mobile terminal generates the first command control to control the mobile terminal to log into the preset server; when detecting the user's first preset touch operation, the mobile terminal displays the locally stored data resource; and when detecting the user's operation of triggering the data resource, the mobile terminal generates the third control command, which carries the triggered data resource and is configured to control the smart TV to output the triggered data resource, and sends the third control command to the server;

Step 903: Resolving the third control command and outputting the triggered data resource.

Wherein, by resolving the third control command, the smart TV can acquire the triggered data resource carried by the second control command, and the smart TV can output the triggered data resource.

In this embodiment, the smart TV can output the triggered data resource according to the third control command sent by the mobile terminal, meeting people's needs of pushing the local data resource stored on the mobile terminals or network data resource to the smart TV to be output.

As another embodiment of the present disclosure, the step that the smart TV receives the third control command sent by the server is as follow: the mobile terminal generates the control command, which carries the data resource with the sequence mark and is configured to control the smart TV to output the triggered data resource in turn according to the sequence mark, and sends the control command to the server, and the smart TV resolves the third control command and outputs the triggered data resource in turn according to the sequence mark.

Wherein, the sequence mark is sequence mark generated by the mobile terminals when determining the output sequence of the triggered data resource and put in the triggered data resource.

In this embodiment, the smart TV outputs the triggered data resource in turn according to the corresponding sequence mark, improving the flexibility of the data resource output.

An embodiment of the present disclosure also discloses another data resource transmission method. The method can be applied to a smart TV. As shown in FIG. 10, the method includes:

Step 1001: Generating an eighth control command to control the mobile terminal to log into a preset server.

Step 1002: Receiving the fifth control command sent by the server.

Wherein, the fifth control command is a control command generated in the following conditions: the mobile terminal determines the type of the triggered data resource; when determining that the triggered data resource is video resource or audio resource, the mobile terminal acquires the paths of the triggered data resource, and generates the fifth control command which carries the paths of the triggered data resource and is configured to turn on the player of the smart TV, and sends the fifth control command to the server.

Step 1003: Turning on the player of the smart TV according to the fifth control command.

Wherein, the player of the smart TV can play video resource or audio resource.

Step 1004: Sending the play request to the server, wherein the server sends the play request to the mobile terminal.

When turning on the player thereof, the smart TV sends the request for playing the triggered video resource or audio resource to the server, and the server sends the play request to the mobile terminal.

Step 1005: Receiving the third control command sent by the server.

Wherein, the third control command is a control command, which carries the triggered data resource and is configured to control the smart TV to output the triggered data resource.

Step 1006: Resolving the third control command and outputting the triggered data resource.

The smart TV acquires the triggered data resource after resolving the third control command, and the triggered data resource is video resource or audio resource, so the smart TV uses the enabled player to play the triggered data resource.

Wherein, after the smart TV resolves the third control command and outputs the triggered data resource, the method may also include:

receiving the sixth control command sent by the server.

Wherein, the sixth control command is a control command generated when the mobile terminal detects that the user triggers the preset operation for controlling the play status; and the sixth control command is a control command corresponding to the preset operation for controlling the generation of the player of the smart TV and play status, and is sent to the server.

Controlling the player of the smart TV to generate the corresponding play status according to the sixth control command.

It is understandable that, when the smart TV outputs the triggered data resource, the play status, e.g. fast forward, backward, close, can be controlled by the mobile terminal.

Another embodiment of the present disclosure discloses a network data resource transmission method. The method can be applied to a mobile terminal. The mobile terminal may be a mobile phone, a pad and any other hand-held device.

See FIG. 11 for details. The method includes the following steps.

Step 1101: Acquiring the IP address of a smart TV, generating and sending a first control command with the IP address of the smart TV to the smart TV, wherein the first control command controls the mobile terminal and the smart TV to access the same local area network.

The mobile terminal and the smart TV locate in the same local area network; the mobile terminal can acquire the IP address of the smart TV by searching the network; the mobile terminal is required to establish WIFI connection with the smart TV, which means that, the mobile terminal sends the first control command which carries the IP address of the smart TV to the smart TV to control the mobile terminal and the smart TV establish the WIFI connection.

Wherein, when the local area network includes a plurality of smart TVs, the mobile terminal can select a specific smart TV to establish the WIFI connection.

Step 1102: When detecting a second preset touch operation of a user, displaying a first network browser

Wherein, the mobile terminal is provided with a second preset touch operation, and the second preset touch operation is an operation for triggering the mobile terminal to display the first network browser.

Specifically, the form of the second preset touch operation may be set upon actual situations. For example, the mobile terminal is provided with a corresponding touch key, while the second preset touch operation may be set as an operation which is triggered by touching the key; when the user triggers the touch key, the mobile terminal can detect the second preset touch operation of the user, and then the mobile terminal displays the first network browser. Of course, the second preset touch operation may also be an operation triggered by shaking the mobile terminal; when the user shakes the mobile terminal once (the specific shaking times can be set according to the actual situations), the mobile terminal can detect the first preset touch operation of the user, and then the mobile terminal displays the first network browser.

The first network browser is a network browser in the prior art; when the user downloads a plurality of network browsers from the mobile terminal, for example LETV browser, YOUKU browser, IQiYi browser, QQ browser, etc., the mobile terminal can display a plurality of first network browsers at the same time when detecting the first preset touch operation of the user.

Optionally, when detecting the first preset touch operation of the user, the mobile terminal can also display a specific first network browser only.

Specifically, when the mobile terminal detects the second preset touch operation of the user, the mobile terminal can call a preset prompt interface for display; the preset prompt interface displays a plurality of the first network browsers on the mobile terminal; when detecting that the user triggers a certain network browser on the prompt interface, the mobile terminal only displays the specific first network browser triggered by the user; and, when detecting the second preset touch operation of the user again, the mobile terminal does not call the preset prompt interface, but directly displays the specific first network browser.

Optionally, when the mobile terminal detects the second preset touch operation of the user, the mobile terminal can also detect number of the times that the plurality of first network browsers are used for, and display the first network browser that ranks the top in terms of the times of use.

Step 1103: When detecting the user's operation of triggering the network data resource, acquiring the storage address of the triggered network data resource.

Wherein, the storage address is a network address with access to the network data resource corresponding to the storage address.

Wherein, after the user enters the first network browser, the first network browser presents various network data resource recommended by the operators; every network data resource has a corresponding storage address; when the mobile terminal detects the user's operation of triggering the network data resource, the mobile terminal can acquire the storage address of the triggered network data resource.

For better understanding, the LETV browser is taken as an example of the description. When a user enters the LETV browser, the webpage of the LETV browser presents various network data resource recommended by the operators, and every network data resource has a corresponding data address, for example, when the LETV browser is opened, items such as “Longmen Express”, “Loyal Yue Fei”, “See The Truth Through Mist”, etc. appear on the webpage; when a user triggers the network data resource of “Longmen Express”, the mobile terminal can acquire the storage address of “Longmen Express”, and play the item through the storage address of “Longmen Express”.

Step 1104: Generating and sending a fourth control command, which carries the storage address of the triggered network data resource and is configured to control the smart TV to call a second network browser to output the triggered network data resource according to the storage address of the triggered network data resource, to the smart TV.

Wherein, the second network browser is a network browser stored in the smart TV.

When the user downloads a plurality of network browsers from the smart TV, the mobile terminal can control the smart TV to call the plurality of second network browsers or call a certain second network browser of the smart TV through the fourth control command, and access the storage address of the triggered network data resource through the called second network browser such that the smart TV outputs the triggered network data resource through the second network browser.

Specifically, the mobile terminal can put the mark of a certain second network browser in the fourth control command to call the second network browser, corresponding to the mark, of the smart TV.

In this embodiment, the network data resource stored in the mobile terminal can be output on the smart TV, meeting people's needs of pushing the network data resource stored on the mobile terminals or network data resource to the smart TV to be output.

Optionally, in the present disclosure, the mobile terminal may also output the triggered network data resource through the first network browser. Specifically, different from the above embodiment, after the mobile terminal detects the user's operation of triggering the network data resource and acquires the storage address of the triggered network data resource, the following is also included:

outputting the triggered data resource through the first network browser.

In such case, the triggered network data resource is output not only on the smart TV, but also on the mobile terminal.

It is required to be noted that, the operation that the mobile terminal outputs the triggered network data resource through the first network browser, and the operation that the mobile terminal generates and sends the fourth control command, which carries the storage address of the triggered network data resource and is configured to control the smart TV to call the second network browser to output the triggered network data resource according to the storage address of the triggered network data resource, to the smart TV, are executed without limit in sequence.

In this embodiment, the triggered network data resource can be output not only on the mobile terminal, but also on the smart TV, so people can watch the data resource on different devices, meeting the expanded needs of people.

Optionally, in the present disclosure, after detecting the fourth preset touch operation of the user, the mobile terminal can generate and send the fourth control command, which carries the storage address of the triggered network data resource and is configured to control the smart TV to call the second network browser to output the triggered network data resource according to the storage address of the triggered network data resource, to the smart TV.

Wherein, the fourth preset touch operation is an operation for triggering the mobile terminal to generate and send the fifth control command. In such case, if not detecting that the user triggers the fourth preset touch operation, the mobile terminal does not generate and send the fifth control command, which carries the storage address of the triggered network data resource and is configured to control the smart TV to call the second network browser and output the network data resource according to the storage address of the network data resource, to the smart TV.

Specifically, the form of the fourth preset touch operation may be set upon actual situations. For example, the mobile terminal is provided with a send key, while the fourth preset touch operation may be set as an operation which is triggered by touching the send key; when the user triggers the send key, the mobile terminal can detect the fourth preset touch operation of the user, and then the mobile terminal generates and sends the fourth control command. Of course, the fourth preset touch operation may also be an operation triggered by shaking the mobile terminal; when the user shakes the mobile terminal once (the specific shaking times can be set according to the actual situations), the mobile terminal can detect the fourth preset touch operation of the user, and then the mobile terminal generates and sends the fifth control command.

It is understandable that, by setting the fourth preset touch operation in the mobile terminal, the user can click a plurality of data resource and then trigger the fourth preset touch operation such that the mobile terminal can generate and send the fifth control command carried out with the plurality of triggered network data resource, and the fifth control command can control the smart TV to call the second network browser to access the storage address of the plurality of triggered network data resource in turn and output the plurality of network data resource in turn through the second network browser.

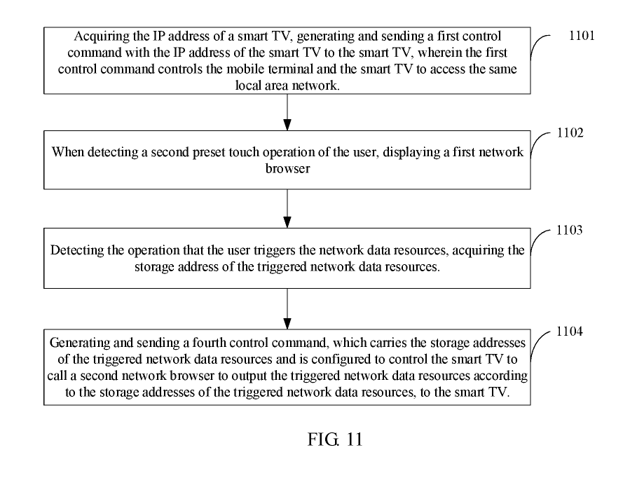

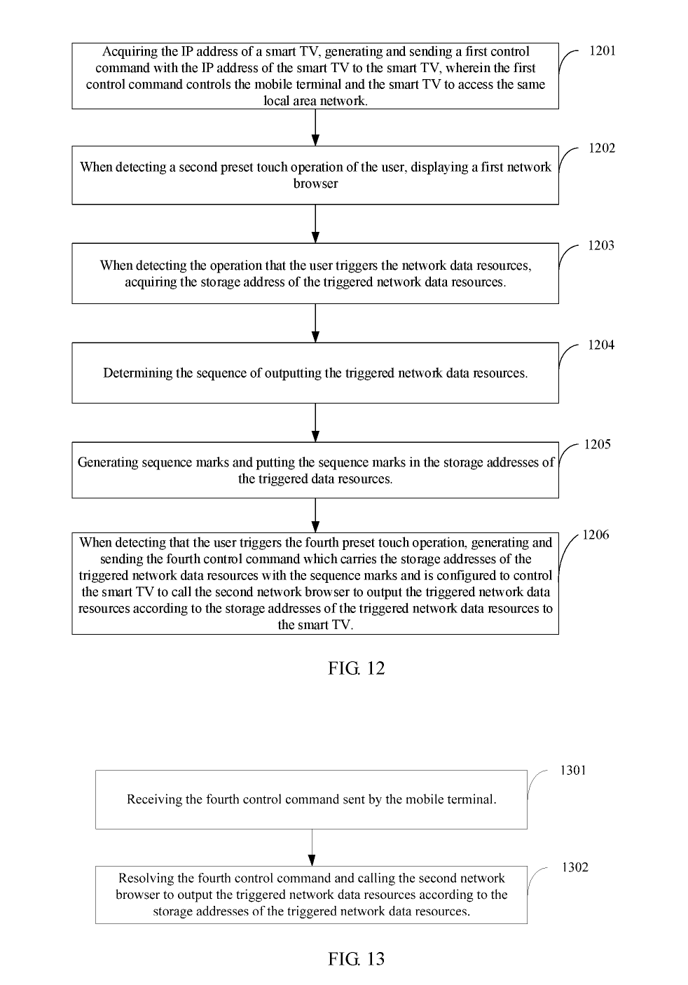

In order to control the sequence of the triggered network data resource output on the smart TV, this embodiment of this present disclosure also discloses a network data resource transmission method. As shown in FIG. 12, the method may include:

Step 1201: Acquiring the IP address of a smart TV, generating and sending a first command with the IP address of the smart TV to the smart TV, wherein the first control command controls the mobile terminal and the smart TV to access the same local area network.

Step 1202: When detecting a second preset touch operation of a user, displaying a first network browser.

Step 1203: When detecting the user's operation of triggering the network data resource, acquiring the storage address of the triggered network data resource.

Step 1204: Determining the output sequence of the triggered network data resource.

When a plurality of network data resources are triggered, the mobile terminal can verify the output sequence of the plurality of network data resource such that the smart TV can output the plurality of triggered network data resource according to the output sequence.

Wherein, a plurality of modes can be used to verify to the output sequence of the triggered network data resource; as a determining mode, the mobile terminal detects the sequence that the plurality of network data resources are triggered and defines the detected sequence as the corresponding output sequence, namely the first triggered network data resource is output to the smart TV first, while the last triggered network data resource is output to the smart TV at last.

Of course, other determining modes are available. As another determining mode, the mobile terminal can detect the number of times that the plurality of triggered data resources are accessed, and define the rank of the detected access times as the corresponding output sequence. For example, the data resources with the maximum access times are output on the smart TV first, while the data resource with the minimum access times is output on the smart TV at last.

It is required to be noted that, the specific determining modes can be set upon the actual situations and are not limited to the above two modes. For example, the mobile terminal can detect the issuing time of the plurality of triggered network data resource on the network and define the detected sequence of the issuing time on the network as the corresponding output sequence. For example, the last network data resource issued on the network is output on the smart TV first, while the earliest network data resource issued on the network is output on the smart TV at last.

Step 1205: Generating sequence mark and putting the sequence mark in the storage address of the triggered data resource.

After the mobile terminal determines the output sequence of the plurality of triggered network data resource, the plurality of the triggered network data resource can be allocated with corresponding sequence mark, and the sequence mark is the mark for distinguishing the output sequence of the triggered network data resource.

Step 1206: When detecting that the user triggers the fourth preset touch operation, generating and sending the fifth control command, which carries the storage address of the triggered network data resource with the sequence mark and is configured to control the smart TV to call the second network browser to output the triggered network data resource according to the storage address of the triggered network data resource, to the smart TV.

The smart TV calls the second network browser according to the fifth control command and accesses the storage address of the triggered network data resource in turn according to the sequence mark such that the second network browser of the smart TV outputs the triggered network resources in turn.

In this embodiment, the mobile terminal can control the second network browser of the smart TV to output the triggered network data resource in turn according to the corresponding sequence, improving the flexibility of the output of the network data resource.

As another embodiment of the present disclosure, the mobile terminal detects the type of the triggered network data resource; and when the mobile terminal detects that the triggered network data resource is network video resource or network audio resource, the mobile terminal generates and sends the fourth control command, which carries the triggered data resource and is configured to control the smart TV to output the triggered data resource, to the smart TV, the method may also include:

generating and sending a seventh control command corresponding to a preset operation which controls the generation of the second network browser of the smart TV and the play status to the smart TV when detecting that the user triggers the preset operation for controlling the play status on the first network browser.

Wherein, the preset operation for controlling the play status may be triggering the second network browser which controls the smart TV to generate preset operation corresponding to the preset operation of the play status.

When the triggered network data resource is network video resource or network audio resource and is output both on the first network browser of the mobile terminal and the second network browser of the smart TV, the mobile terminal can detect control the second network browser to play the play status of the video resource and audio resource when detecting that the user triggers the preset operation on the first network browser to control the play status.

Wherein, various present operations for controlling the play status may be available, e.g. fast forward, backward, close, pause. etc. The specific preset operation for controlling the play status is displayed on the webpage where the first network browser plays the network video resource or network audio resource.

For example, when the user triggers the “Pause” key on the first network browser, the mobile terminal can detect that the user triggers the preset operation of the first network browser for controlling the play to pause; correspondingly, the mobile terminal generates and sends the seventh control command for controlling the second network browser of the smart TV to generate the “fast forward” play status to the smart TV, so the smart TV controls the second network browser to stop playing the triggered network data resource according to the seventh control command.

An embodiment of the present disclosure also discloses another network data resource transmission method. The method can be applied to a smart TV. As shown in FIG. 13, the method may include:

Step 1301: Receiving the fourth control command sent by the mobile terminal.

Wherein, the fourth control command is a control command generated in the following conditions: the mobile terminal acquires the IP address of the smart TV, generates and sends the first control command, which carries the IP address of the smart TV to the smart TV; the first control command controls the mobile terminal and the smart TV to access the same local area network; when detecting the first preset touch operation of the user, the mobile terminal displays the first network browser; when detecting the user's operation of triggering the network data resource, the mobile terminal acquires the storage address of the triggered network data resource and generates the fourth control command, which carries the storage address of the triggered network data resource and is configured to control the smart TV to call the second network browser to output the triggered network data resource according to the storage address of the triggered network data resource.

Step 1302: Resolving the fourth control command and calling the second network browser to output the triggered network data resource according to the storage address of the triggered network data resource.

Wherein, by resolving the fourth control command, the smart TV can acquire the storage address of the triggered network data resource carried by the fourth control command, and can access the storage address of the triggered network data resource through the second network browser to further output the triggered data resource.

It is required to be noted that, when the fourth control command carries the mark of a certain second network browser, the smart TV can call the second network browser corresponding to the mark according to the mark of the second network browser, and output the triggered network data resource through the second network browser.

In this embodiment, the smart TV can output the triggered data resource on the second network browser according to the fourth control command sent by the mobile terminal, meeting people's needs of pushing the network data resource stored on the mobile terminal to the smart TV to be output.

As another embodiment of the present disclosure, the step that the smart TV receives the fourth control command sent by the mobile terminal is as follow: the mobile terminal generates the control command that carries the storage address of the network data resource with the sequence mark and is configured to control the smart TV to call the second network browser to output the triggered network data resource in turn according to the sequence mark and the storage address of the triggered network data resource; then, the smart TV resolves the fourth control command and calls the second network browser to output the triggered network data resource in turn according to the sequence mark and the storage address of the triggered network data resource.

Wherein, the sequence mark is sequence mark that is generated by the mobile terminals when determining the output sequence of the triggered network data resource and carried in the storage address of the triggered network data resource.

In this embodiment, by resolving the fourth control command, the smart TV can acquire the triggered network data resource and the corresponding sequence mark; and the smart TV can call the second network browser to access and output the storage address of the triggered network data resource corresponding to the sequence mark in turn according to the sequence mark.

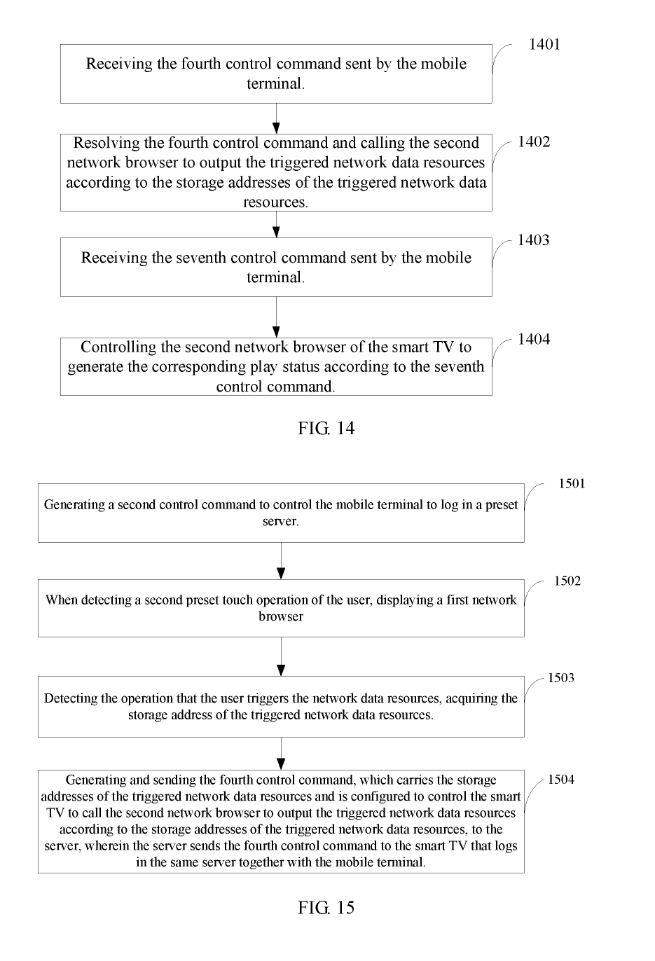

An embodiment of the present disclosure also discloses another network data resource transmission method. The method can be applied to a smart TV. As shown in FIG. 14, the method may include:

Step 1401: Receiving the fourth control command sent by the mobile terminal.

Step 1402: Resolving the fourth control command and calling the second network browser to output the triggered network data resource according to the storage address of the triggered network data resource.

Step 1403: Receiving the seventh control command sent by the mobile terminal.

Wherein, the seventh control command is a control command generated by the mobile terminal; when detecting that the user triggers the preset operation, which controls the play status, on the first network browser, the mobile terminal generates the seventh control command to control the second network browser of the smart TV to generate the preset operation corresponding to the play status

Step 1404: Controlling the second network browser of the smart TV to generate the corresponding play status according to the fourth control command.

Wherein, when the second network browser of the smart TV plays the network video resource or network audio resource, the playing webpage is also provided with the preset operations for controlling the play status, for example, “fast forward, fast backward, pause, close”, etc.; after receiving the third control command sent by the mobile terminal, the smart TV can control the preset operation for controlling the play status on the second network browser of the smart TV to generate the corresponding play status according to the third control command.

The present disclosure also discloses a network data resource transmission method. The method can be applied to a mobile terminal. The mobile terminal may be a mobile phone, a pad and any other hand-held device.

See FIG. 15 for details. The method includes the following steps.

Step 1501: Generating a second control command to control the mobile terminal to log into a preset server.

When the mobile terminal and the smart TV are in different local area networks, it is required to move the mobile terminal and the smart TV to log into the same server.

Specifically, the user can perform login by entering an account number and password on the mobile terminal; of course, setting a password is not necessary, the login is performed by only entering the account number of the server into the mobile terminal; when the user triggers the login button, the mobile terminal generates the first control command to control the mobile terminal to log into the preset server corresponding to the account number.

Step 1502: When detecting a second preset touch operation of a user, displaying a first network browser.

Wherein, the mobile terminal is provided with a second preset touch operation, and the second preset touch operation is an operation for triggering the mobile terminal to display the first network browser.

Specifically, the form of the second preset touch operation may be set upon actual situations. For example, the mobile terminal is provided with a corresponding touch key, while the second preset touch operation may be set as an operation which is triggered by touching the key; when the user triggers the touch key, the mobile terminal can detect the second preset touch operation of the user, and then the mobile terminal displays the first network browser. Of course, the second preset touch operation may also be an operation triggered by shaking the mobile terminal; when the user shakes the mobile terminal once (the specific shaking times can be set according to the actual situations), the mobile terminal can detect the first preset touch operation of the user, and then the mobile terminal displays the first network browser.

The first network browser is a network browser in the prior art; when the user downloads a plurality of network browsers from the mobile terminal, for example LETV browser, YOUKU browser, IQiYi browser, QQ browser, etc., the mobile terminal can display a plurality of first network browsers at the same time when detecting the first preset touch operation of the user.

Optionally, when detecting the second preset touch operation of the user, the mobile terminal can also display a specific first network browser only.

Specifically, when the mobile terminal detects the second preset touch operation of the user, the mobile terminal can call a preset prompt interface for display; the preset prompt interface displays a plurality of the first network browsers on the mobile terminal; when detecting that the user triggers a certain network browser on the prompt interface, the mobile terminal only displays the specific first network browser triggered by the user; and, when detecting the second preset touch operation of the user again, the mobile terminal does not call the preset prompt interface, but directly displays the specific first network browser.

Optionally, when the mobile terminal detects the second preset touch operation of the user, the mobile terminal can also detect number of the times that the plurality of first network browsers are used for, and display the first network browser that ranks the top in terms of the times of use.

Step 1503: When detecting the user's operation of triggering the network data resource, acquiring the storage address of the triggered network data resource.

Wherein, the storage address is a network address with access to the network data resource corresponding to the storage address.

Wherein, after the user enters the first network browser, the first network browser presents various network data resource recommended by the operators; every network data resource has a corresponding storage address; when the mobile terminal detects the user's operation of triggering the network data resource, the mobile terminal can acquire the storage address of the triggered network data resource.

For better understanding, the LETV browser is taken as an example of the description. When a user enters the LETV browser, the webpage of the LETV browser presents various network data resource recommended by the operators, and every network data resource has a corresponding data address, for example when the LETV browser is opened, items such as “Longmen Express”, “Loyal Yue Fei”, “See The Truth Through Mist”, etc. appear on the webpage; when a user triggers the network data resource of “Longmen Express”, the mobile terminal can acquire the storage address of “Longmen Express”, and play the item through the storage address of “Longmen Express”.

Step 1504: Generating and sending the fourth control command, which carries the storage address of the triggered network data resource and is configured to control the smart TV to call the second network browser to output the triggered network data resource according to the storage address of the triggered network data resource, to the server, wherein the server sends the fourth control command to the smart TV that logs into the same server together with the mobile terminal.

Wherein, only when the smart TV and the mobile terminal log into the same server can the smart TV receive the fourth control command sent by the server.

If several smart TVs log into the same server together with the mobile terminal, the mobile terminal can select a specific smart TV; the mobile terminal sends the fourth control command to the server; then, the server sends the fourth control command to the specific smart TV. Of course, the server can sends the fourth control command to one of the several smart TVs logging in the same server together with the mobile terminal.

Wherein, the second network browser is a network browser stored in the smart TV.

When the user downloads a plurality of network browsers from the smart TV, the mobile terminal can control the smart TV to call the plurality of second network browsers or call a certain second network browser of the smart TV through the fourth control command, and access the storage address of the triggered network data resource through the called second network browser such that the smart TV outputs the triggered network data resource through the second network browser.

Specifically, the mobile terminal can put the mark of a certain second network browser in the fourth control command to call the second network browser, corresponding to the mark, of the smart TV.

In this embodiment, the network data resource stored in the mobile terminal can be output on the smart TV, meeting people's needs of pushing the network data resource stored on the mobile terminals or network data resource to the smart TV to be output.

Optionally, in the present disclosure, the mobile terminal may also output the triggered network data resource through the first network browser. Specifically, different from the above embodiment, after the mobile terminal detects the user's operation of triggering the network data resource and acquires the storage address of the triggered network data resource, the following is also included:

outputting the triggered data resource through the first network browser.

In such case, the triggered network data resource is output not only on the smart TV, but also on the mobile terminal.

It is required to be noted that, the operation that the mobile terminal outputs the triggered network data resource through the first network browser, and the operation that the mobile terminal generates and sends the fourth control command, which carries the storage address of the triggered network data resource and is configured to control the smart TV to call the second network browser to output the triggered network data resource according to the storage address of the triggered network data resource, to the server, is executed without limit in sequence.

In this embodiment, the triggered network data resource can be output not only on the mobile terminal, but also on the smart TV, so people can watch the data resource on different devices, meeting the expanded needs of people.

Optionally, in the present disclosure, after detecting the fourth preset touch operation of the user, the mobile terminal can generate and send the fourth control command, which carries the storage address of the triggered network data resource and is configured to control the smart TV to call the second network browser and output the triggered network data resource according to the storage address of the triggered network data resource, to the server, and the server sends the fourth control command to the smart TV that logs into the same server together with the mobile terminal.

Wherein, the fourth preset touch operation is an operation for triggering the mobile terminal to generate and send the fourth control command. In such case, if not detecting that the user triggers the fourth preset touch operation, the mobile terminal does not generate and send the fourth control command, which carries the storage address of the triggered network data resource and is configured to control the smart TV to call the second network browser and output the network data resource according to the storage address of the network data resource, to the server.

Specifically, the form of the fourth preset touch operation may be set upon actual situations. For example, the mobile terminal is provided with a send key, while the fourth preset touch operation may be set as an operation which is triggered by touching the send key; when the user triggers the send key, the mobile terminal can detect the fourth preset touch operation of the user, and then the mobile terminal generates and sends the fourth control command. Of course, the second preset touch operation may also be an operation triggered by shaking the mobile terminal; when the user shakes the mobile terminal once (the specific shaking times can be set according to the actual situations), the mobile terminal can detect the second preset touch operation of the user, and then the mobile terminal generates and sends the fourth control command.

It is understandable that, by setting the fourth preset touch operation in the mobile terminal, the user can click a plurality of data resource and then trigger the fourth preset touch operation such that the mobile terminal can generate and send the fourth control command with the plurality of triggered network data resource, and the fourth control command can control the smart TV to call the second network browser to access the storage address of the plurality of triggered network data resource in turn and output the plurality of network data resource in turn through the second network browser.

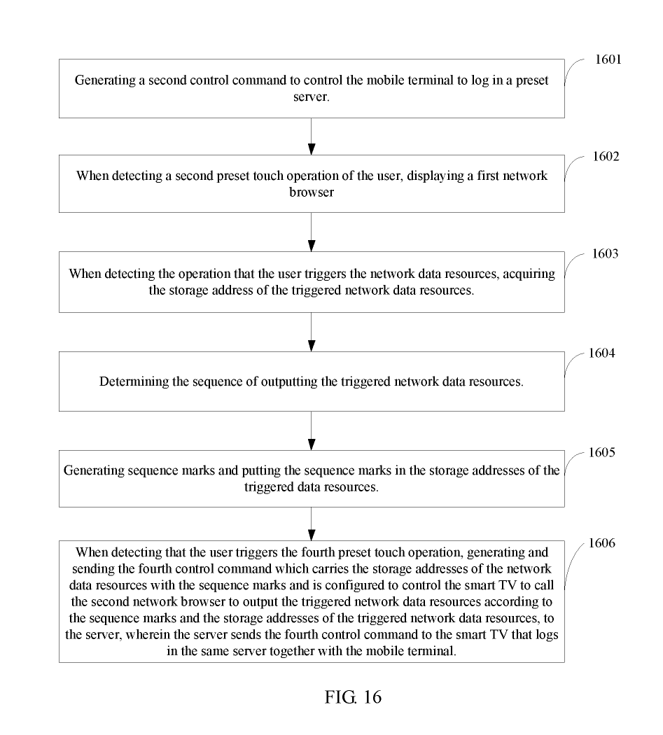

In order to control the sequence of the triggered network data resource output on the smart TV, this embodiment of this present disclosure also discloses a network data resource transmission method. As shown in FIG. 16, the method may include:

Step 1601: Generating a second control command to control the mobile terminal to log into a preset server.

Step 1602: When detecting a second preset touch operation of a user, displaying a first network browser.

Step 1603: When detecting the user's operation of triggering the network data resource, acquiring the storage address of the triggered network data resource.

Step 1604: Determining the output sequence of the triggered network data resource.

When a plurality of network data resources are triggered, the mobile terminal can verify the output sequence of the plurality of network data resource such that the smart TV can output the plurality of triggered network data resource according to the output sequence.

Wherein, a plurality of modes can be used to verify to the output sequence of the triggered network data resource; as a determining mode, the mobile terminal detects the sequence that the plurality of network data resources are triggered and defines the detected sequence as the corresponding output sequence, namely the first triggered network data resource is output to the smart TV first, while the last triggered network data resource is output to the smart TV at last.

Of course, other determining modes are available. As another determining mode, the mobile terminal can detect the number of times that the plurality of triggered data resources are accessed, and define the rank of the detected access times as the corresponding output sequence. For example, the data resource with the maximum access times are output on the smart TV first, while the data resource with the minimum access times is output on the smart TV at last.

It is required to be noted that, the specific determining modes can be set upon the actual situations and are not limited to the above two modes. For example, the mobile terminal can detect the issuing time of the plurality of triggered network data resource on the network and define the detected sequence of the issuing time on the network as the corresponding output sequence. For example, the last network data resource issued on the network is output on the smart TV first, while the earliest network data resource issued on the network are output on the smart TV at last.

Step 1605: Generating sequence mark and putting the sequence mark in the storage address of the triggered data resource.

After the mobile terminal determines the output sequence of the plurality of triggered network data resource, the plurality of the triggered network data resource can be allocated with corresponding sequence mark, and the sequence mark is the mark for distinguishing the output sequence of the triggered network data resource.

Step 1606: When detecting that the user triggers the fourth preset touch operation, generating and sending the fourth control command, which carries the storage address of the network data resource with the sequence mark and is configured to control the smart TV to call the second network browser to output the triggered network data resource according to the sequence mark and the storage address of the triggered network data resource, to the server, wherein the server sends the fourth control command to the smart TV that logs into the same server together with the mobile terminal.

The smart TV calls the second network browser according to the fourth control command and accesses the storage address of the triggered network data resource in turn according to the sequence mark such that the second browser of the smart TV outputs the triggered network data resource in turn.

In this embodiment, the mobile terminal can control the second network browser of the smart TV to output the triggered network data resource in turn according to the corresponding sequence, improving the flexibility of the output of the network data resource.

As another embodiment of the present disclosure, the mobile terminal detects the type of the triggered network data resource; and the mobile terminal generates and sends the fourth control command, which carries the triggered data resource and is configured to control the smart TV to output the triggered data resource to the server when the mobile terminal detects that the triggered network data resource is network video resource or network audio resource, and the server sends the fourth control command to the smart TV that logs in the same server together with the mobile terminal. Then, the method can also include:

when detecting that the user triggers the preset operation, which controls the play status, on the first network browser, generating and sending the seventh control command corresponding to the preset operation which controls the generation of the second network browser and the play status of the smart TV, to the server, wherein the server sends the seventh control command to the smart TV that logs into the same server together with the mobile terminal.

Wherein, the preset operation can be an operation for triggering the preset operation to control the generation of the second network browser and play status of the smart TV.

When the triggered network data resource is network video resource or network audio resource and is output both on the first network browser of the mobile terminal and the second network browser of the smart TV, the mobile terminal can detect control the second network browser to play the play status of the video resource and audio resource when detecting that the user triggers the preset operation on the first network browser to control the play status.

Wherein, various present operations for controlling the play status may be available, e.g. fast forward, backward, close, pause. etc. The specific preset operation for controlling the play status is displayed on the webpage where the first network browser plays the network video resource or network audio resource.

For example, when the user triggers the “Pause” key on the first network browser, the mobile terminal can detect that the user triggers the preset operation of the first network browser for controlling the play to pause; correspondingly, the mobile terminal generates and sends the seventh control command for controlling the second network browser of the smart TV to generate the “fast forward” play status to the server, and the server sends the seventh control command to the smart TV that logs in the same server together with the mobile terminal, and then the smart TV controls the second network browser to stop playing the triggered network data resource according to the seventh control command.

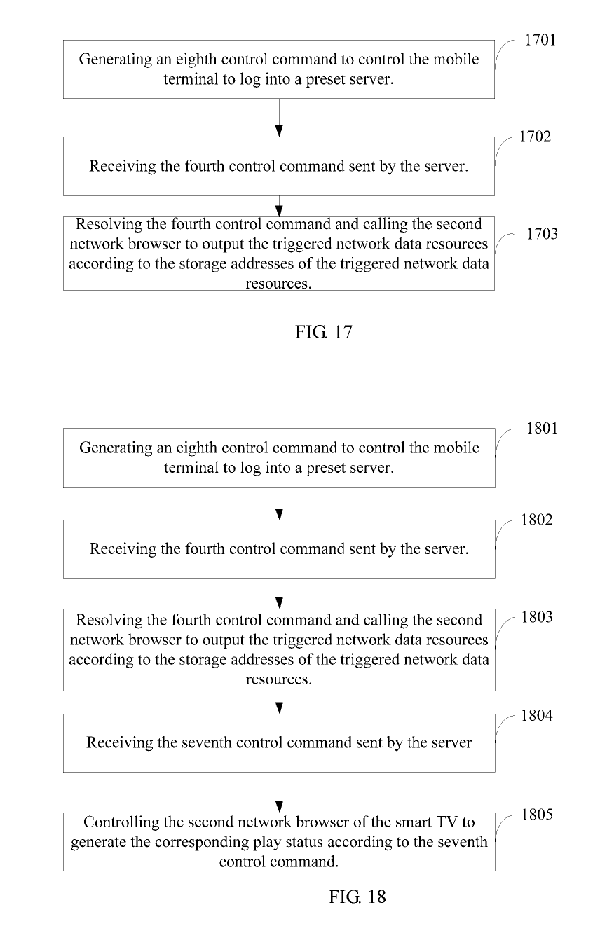

An embodiment of the present disclosure also discloses another network data resource transmission method. The method can be applied to a smart TV. As shown in FIG. 17, the method includes:

Step 1701: Generating an eighth control command to control the mobile terminal to log into a preset server.

Wherein, when the data resource in the above mobile terminal is required to be output via the smart TV, the smart TV and the mobile terminal log into the same server, and the user can perform login by entering an account number and password on the mobile terminal; of course, setting a password is not necessary, the login is performed by only entering the account number of the server into the mobile terminal; when the user triggers the login button, the mobile terminal generates the fourth control command to control the smart TV to log into the preset server corresponding to the account number.

Step 1702: Receiving the fourth control command sent by the server.

Wherein, the fourth control command is a control command generated in the following conditions: the mobile terminal generates the first control command to control the mobile terminal to log into the preset server; when detecting the first preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server.

Step 1703: Resolving the fourth control command and calling the second network browser to output the triggered network data resource according to the storage address of the triggered network data resource.

Wherein, by resolving the fourth control command, the smart TV can acquire the triggered network data resource carried by the fourth control command, and can access the storage address of the triggered network data resource through the second network browser to further output the triggered data resource.

It is required to be noted that, when the fourth control command carries the mark of a certain second network browser, the smart TV can call the second network browser corresponding to the mark according to the mark of the second network browser, and output the triggered network data resource through the second network browser.

In this embodiment, the smart TV can output the triggered network data resource on the second network browser according to the fourth control command sent by the server, meeting people's needs of pushing the network data resource stored on the mobile terminal to the smart TV to be output.

As another embodiment of the present disclosure, the step that the smart TV receives the fourth control command sent by the server is as follow: the mobile terminal generates the fourth control command, which carries the storage address of the network data resource with the sequence mark and is configured to control the smart TV to call the second network browser to output the triggered network data resource in turn according to the sequence mark and the storage address of the triggered network data resource, and sends the fourth control command to the servers; then, the smart TV resolves the fourth control command and calls the second network browser to output the triggered network data resource in turn according to the sequence mark and the storage address of the triggered network data resource.

Wherein, the sequence mark is sequence mark that is generated by the mobile terminals when determining the output sequence of the triggered network data resource and carried in the storage address of the triggered network data resource.

In this embodiment, by resolving the fourth control command, the smart TV can acquire the triggered network data resource and the corresponding sequence mark; and the smart TV can call the second network browser to access and output the storage address of the triggered network data resource corresponding to the sequence mark in turn according to the sequence mark.

An embodiment of the present disclosure also discloses another network data resource transmission method. The method can be applied to a smart TV. As shown in FIG. 18, the method may include:

Step 1801: Generating an eighth control command to control the smart TV to log into a preset server.

Step 1802: Receiving the fourth control command sent by the server.

Wherein, the fourth control command is a control command generated in the following conditions: the mobile terminal generates the first control command to control the mobile terminal to log into the preset server; when detecting the first preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server.

Step 1803: Resolving the fourth control command and calling the second network browser to output the triggered network data resource according to the storage address of the triggered network data resource.

Step 1804: Receiving the seventh control command sent by the server.

Wherein, the seventh control command is a control command generated under the following conditions: when detecting that the user triggers the preset operation, which controls the play status, on the first network browser, the mobile terminal generates the seventh control command, which controls the second network browser of the smart TV to generate the preset operation corresponding to the play status, and sends the seventh control command to the server.

Step 1805: Controlling the second network browser of the smart TV to generate the corresponding play status according to the seventh control command.

Wherein, when the second network browser of the smart TV plays the network video resource or network audio resource, the playing webpage is also provided with the preset operations for controlling the play status, for example, “fast forward, fast backward, pause, close”, etc.; after receiving the seventh control command sent by the mobile terminal, the smart TV can control the preset operation for controlling the play status on the second network browser of the smart TV to generate the corresponding play status according to the seventh control command.

The present disclosure also discloses computer readable recording media for recording programs for executing the above methods.

The computer readable recording media include any mechanisms for storing or transmitting information in a computer (for example, PC) readable form. For example, the computer readable media include read-only memory (ROM), random access memory (RAM), disc storage media, optical storage media, flash storage media, electric, optical, acoustic transmission signals or transmission signals in other forms (for example, carrier, infrared signal, digital signal, etc.).

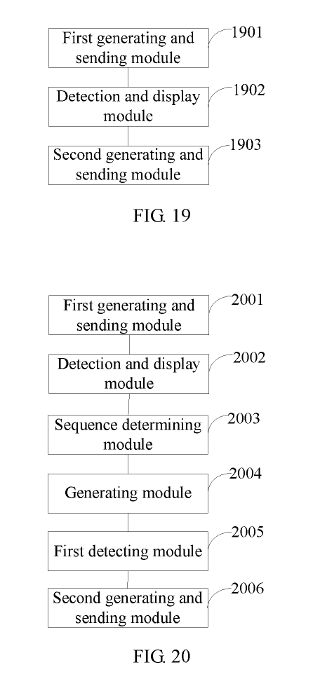

An embodiment of the present disclosure also discloses a data resource transmission device. The device can be applied to the mobile terminals. Refer to FIG. 19. The device includes: a first generating and sending module 1901, a detection and display module 1902 and a second generating and sending module 1903, wherein,

the first generating and sending module 1901 is configured to acquire the IP address of a smart TV, generate and send a first control command with the IP address of the smart TV to the smart TV; the first control command controls the mobile terminal and the smart TV to access the same local area network;

the detection and display module 1902 is configured to display locally stored data resource when detecting a first preset touch operation of a user; and,

the second generating and sending module 1903 is configured to generate and send a third control command, which carries the triggered data resource and is configured to control the smart TV to output the triggered data resource, to the smart TV when detecting user's operation of triggering the data resource.

In this embodiment, the local data resource stored in the mobile terminal can be output on the smart TV, meeting people's needs of pushing the local data resource stored on the mobile terminals or network data resource to the smart TV to be output.

As another embodiment, in the present disclosure, the device may also include a local output module.

Wherein, the local output module is configured to locally output the triggered data resource after detecting a user's operation of triggering the data resource.

Correspondingly, the triggered data resource is output not only on the smart TV, but also on the mobile terminal.

As another embodiment, in the present disclosure, the device may also include a third detection module.

Wherein, the third detection module is configured to detect a third preset touch operation of a user.

The second generating and sending module 604 is specifically configured to generate and send a third control command, which carries the triggered data resource and is configured to control the smart TV to output the triggered data resource, to the smart TV, when the first detection module detects a second preset touch operation of the user.

In order to control the output sequence of the triggered data resource on the smart TV, an embodiment of the present disclosure also discloses a data resource transmission device. The device can be applied to the mobile terminals. As shown in FIG. 20, the device may include: a first generating and sending module 2001, a detection and display module 2002, a sequence determining module 2003, a generation module 2004, a first detection module 2005 and a second generating and sending module 2006, wherein:

the first generating and sending module 2001 is configured to acquire the IP address of a smart TV, generate and send a first command with the IP address of the smart TV to the smart TV; the first control command controls the mobile terminal and the smart TV to access the same local area network;

the detection and display module 2002 is configured to display locally stored data resource when detecting a first preset touch operation of a user;

the sequence determining module 2003 is configured to determine the output sequence of the triggered data resource when detecting the user's operation of triggering the data resource;

the generation module 2004 is configured to generate the sequence mark and put the sequence mark in the triggered data resource;

the first detection module 2005 is configured to detect a third preset touch operation of a user; and,

the second generating and sending module 2006 is configured to generate and send a third control command, which carries the triggered data resource with the sequence mark and is configured to control the smart TV to output the triggered data resource in turn according to the sequence mark, to the smart TV, when the first detection module 2005 detects the user's operation of triggering the data resource.

In this embodiment, the mobile terminal can control the smart TV to output the triggered data resource in turn according to the corresponding sequence, improving the flexibility of the data resource output.

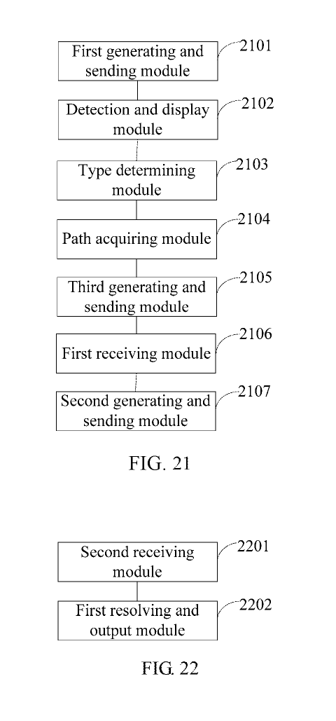

An embodiment of the present disclosure also discloses a data resource transmission device. The device can be applied to a mobile terminal. As shown in FIG. 21, the device may include: a first generating and sending module 2101, a detection and display module 2102, a type determining module 2103, a path acquiring module 2104, a third generating and sending module 2105, a first receiving module 2106 and a second generating and sending module 2107, wherein,

the first generating and sending module 2101 is configured to acquire the IP address of a smart TV, generate and send a first command with the IP address of the smart TV to the smart TV; the first control command controls the mobile terminal and the smart TV to access the same local area network;

the detection and display module 2102 is configured to display locally stored data resource when detecting a first preset touch operation of a user; and,

the type determining module 2103 is configured to determine the type of the triggered data resource when detecting the user's operation of triggering the data resource;

the path acquiring module 2104 is configured to acquire the paths of the triggered data resource when the type determining module 1204 determines the triggered data resource is video resource or audio resource;

the third generating and sending module 2105 is configured to generate and send a fifth control command which carries the paths of the triggered data resource to the smart TV, wherein the fifth control command is used for turning on the player of the smart TV;

the first receiving module 2106 is configured to receive a play request sent by the smart TV after turning on the player; and,

the second generating and sending module 2107 is specifically configured to generate and send a third control command, which carries the triggered data resource and is configured to control the smart TV to output the triggered data resource, to the smart TV, when the first detection module 2106 receives the play request after the smart TV turns on the player.

Optionally, in the present disclosure, the device may also include:

a fourth generating and sending module, configured to generate and send a sixth control command, corresponding to the preset operation which controls the generation of the player of the smart TV and the play status, to the smart TV, when detecting that the user triggers the preset operation for controlling the play status, after the second generating and sending module generates and sends the third control command, which carries the triggered data resource and is configured to control the smart TV to output the triggered data resource, to the smart TV;

Wherein, the preset operation for controlling the play status can be configured as triggering the player for controlling the smart TV to generate the operation corresponding to the preset operation of the play status.

An embodiment of the present disclosure also discloses another data resource transmission device. The device can be applied to a mobile terminal. Refer to FIG. 22. The device includes: a second receiving module 2201 and a first resolving and output module 2202, wherein,

the second receiving module 2201 is configured to receive the second control command sent by the mobile terminal, wherein the second control command is a control command generated under the following conditions: the mobile terminal acquires the IP address of a smart TV, generates and sends the first command with the IP address of the smart TV to the smart TV; the first control command controls the mobile terminal and the smart TV to access the same local area network; when detecting the first preset touch operation of the user, the mobile terminal displays the locally stored data resource; and when detecting the user's operation of triggering the data resource, the mobile terminal generates the second control command, which carries the triggered data resource and is configured to control the smart TV to output the triggered data resource;

the first resolving and output module 2202 is configured to resolve the second control command and output the triggered data resource.

In this embodiment, the smart TV can output the triggered data resource according to the second control command sent by the mobile terminal, meeting people's needs of pushing the local data resource stored on the mobile terminals or network data resource to the smart TV to be output.

Wherein, the second receiving module receives the second control command sent by the mobile terminal in this way: when the mobile terminal generates the control command, which carries the data resource with the sequence mark and is configured to control the smart TV to output the triggered data resource in turn according to the sequence mark, the first receiving and output module is specifically configured to output the triggered data resource in turn according to the sequence mark.

Wherein, the sequence mark is sequence mark generated by the mobile terminals when determining the output sequence of the triggered data resource and put in the triggered data resource.

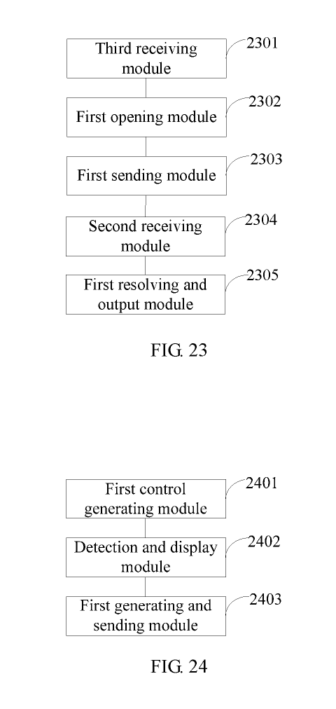

An embodiment of the present disclosure also discloses another device of data transmission. Refer to FIG. 23. The device may include a third receiving module 2301, a first opening module 2302, a first sending module 2303, a second receiving module 2304 and a first resolving and output module 2305, wherein,

the third receiving module 2301 is configured to receive the fifth control command sent by the mobile terminal.

Wherein, the fifth control command is a control command generated in the following conditions: the mobile terminal determines the type of the triggered data; when determining that the triggered data resource is video resource or audio resource, the mobile terminal acquires the paths of the triggered data resource, and generates the fifth control command which carries the paths of the triggered data resource and is configured to turn on the player of the smart TV.

The first opening module 2302 is configured to turn on the player of the smart TV according to the fifth control command.

The first sending module 2303 is configured to send the play request to the mobile terminal.

The second receiving module 2304 is configured to receive third control command sent by the mobile terminal after the first sending module 2303 sends the play request to the mobile terminal.

The first resolving and output module 2305 is configured to resolve the third control command and output the triggered data resource.

Wherein, in the present disclosure, the device also includes a fourth receiving module and a control module, wherein,

the fourth receiving module is configured to receive the sixth control command sent by the mobile terminal after the resolving and output module resolves the third control command and outputs the triggered data resource;

wherein, the sixth control command is a control command generated under the following conditions: when detecting that user triggers the preset operation for controlling the play status, the mobile terminal generates the sixth control command corresponding to the preset operation for controlling the player generation and play status of the smart TV;

the control module is configured to control the player of the smart TV to generate the corresponding play status according to the sixth control command.

The specific realization modes of the above devices refer to the corresponding embodiments of the methods in the Description, and therefore are not repeated here.

In the above device, after the mobile terminal and the smart TV establish the WIFI connection, the mobile terminal displays the locally stored data resource when detecting the first preset touch operation of the user, generates and sends the third control command, which carries the triggered data resource and is configured to the control the smart TV to output the data resource, to the smart TV, when detecting the user's operation of triggering the data resource; after receiving the third control command, the smart TV resolves the third control command and outputs the triggered data resource. The present disclosure fulfills the aim of outputting the data resource locally stored in the mobile terminal on the smart TV, meeting peoples' needs pushing the data resource locally stored in the mobile terminal to the smart TV to be output.

An embodiment of the present disclosure also discloses another data resource transmission device. The device can be applied to a mobile terminal. Refer to FIG. 24. The device may include: a first control generating module 2401, a detection and display module 2402 and a first generating and sending module 2403, wherein,

the first control generating module 2401 is configured to generate a second control command to control the mobile terminal to log into a preset server;

the detection and display module 2402 is configured to display locally stored data resource when detecting a first preset touch operation of a user; and,

the second generating and sending module 2403 is configured to generate and send the third command, which carries the triggered data resource and is configured to control the smart TV to output the triggered data resource, to the server when detecting the user's operation of triggering the data resource, wherein the server sends the third control command to the smart TV which logs into the same server together with the mobile terminal.

In this embodiment, the local data resource stored in the mobile terminal can be output on the smart TV, meeting people's needs of pushing the local data resource stored on the mobile terminals or network data resource to the smart TV to be output.

As another embodiment, in the present disclosure, the device may also include a local output module.

Wherein, the local output module is configured to locally output the triggered data resource after detecting a user's operation of triggering the data resource.

Correspondingly, the triggered data resource is output not only on the smart TV, but also on the mobile terminal.

As another embodiment, in the present disclosure, the device may also include a third detection module.

Wherein, the third detection module is configured to detect a third preset touch operation of a user.

The first generating and sending module is specifically configured to generate and send the third control command, which carries the triggered data resource and is configured to control the smart TV to output the triggered data resource, to the server when the third detection module detects the third preset touch operation of the user, wherein the server sends the third control command to the smart TV which logs into the same server together with the mobile terminal.

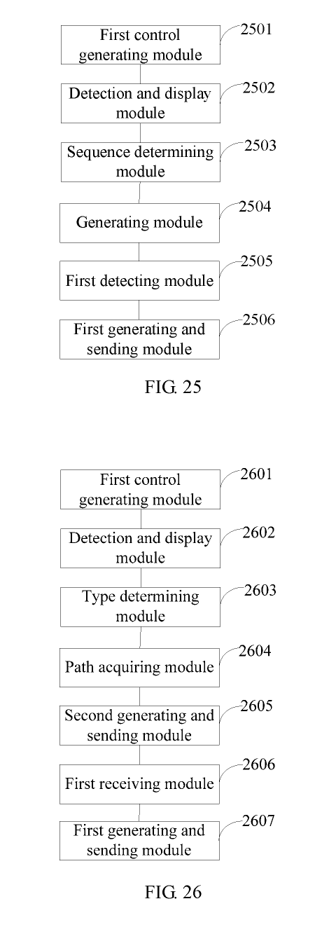

In order to control the output sequence of the triggered data resource on the smart TV, an embodiment of the present disclosure also discloses a data resource transmission device. The device can be applied to a mobile terminal. As shown in FIG. 25, the device may include: a first control generating module 2501, a detection and display module 2502, a sequence determining module 2503, a generation module 2504, a first detection module 2505 and a first generating and sending module 2506, wherein

the first control generating module 2501 is configured to generate a second control command to control the mobile terminal to log into a preset server;

the detection and display module 2502 is configured to display locally stored data resource when detecting a first preset touch operation of a user;

the sequence determining module 2503 is configured to determine the output sequence of the triggered data resource when detecting the user's operation of triggering the data resource;

the generation module 2504 is configured to generate the sequence mark and put the sequence mark in the triggered data resource;

the first detection module 2505 is configured to detect a third preset touch operation of a user; and

the first generating and sending module 2506 is configured to generate and send the third command, which carries the data resource with the sequence mark and is configured to control the smart TV to output the triggered data resource, to the server, when the first detection module 2505 detects the user's operation of triggering the data resource, wherein the server sends the third control command to the smart TV which logs into the same server together with the mobile terminal.

In this embodiment, the mobile terminal can control the smart TV to output the triggered data resource in turn according to the corresponding sequence, improving the flexibility of the data resource output.

An embodiment of the present disclosure also discloses a data resource transmission device. The device can be applied to a mobile terminal. As shown in FIG. 26, the device may include: a first control generating module 2601, a detection and display module 2602, a type determining module 2603, a path acquiring module 2604, a second generating and sending module 2605, a first receiving module 2606 and a first generating and sending module 2607, wherein,

the first control generating module 2601 is configured to generate a second control command to control the mobile terminal to log into a preset server;

the detection and display module 2602 is configured to display locally stored data resource when detecting a first preset touch operation of a user;

the type determining module 2603 is configured to determine the type of the triggered data resource when detecting the user's operation of triggering the data resource;

the path acquiring module 2604 is configured to acquire the paths of the triggered data resource when the type determining module 2603 determines the triggered data resource is video resource or audio resource;

the second generating and sending module 2605 is configured to generate and send a fifth control command which carries the path of the triggered data resource to the server, wherein the server sends the fifth control command to the smart TV which logs into the same sever together with the mobile terminal, and the fifth control command is configured to turn on the player of the smart TV;

the first receiving module 2606 is configured to receive a play request sent by the server, wherein, the play request is a play request sent to the server after the smart TV logging into the same server together with the mobile terminal turns on the player;

the first generating and sending module 2607 is configured to generate and send the third command, which carries the triggered data resource and is configured to control the smart TV to output the triggered data resource, to the server, when the first receiving module 2606 receives the play request sent by the server, wherein the server sends the third control command to the smart TV that logs in the same server together with the mobile terminal.

Optionally, in the present disclosure, the device may also include:

a third generating and sending module, configured to generate and send a six control command, corresponding to a preset operation which controls the generation of the player of the smart TV and the player status, to the server when detecting that the user triggers the preset operation for controlling the play status after the first generating and sending module generates and sends the third control command, which carries the triggered data resource and is configured to control the smart TV to output the triggered data resource, to the server and the server sends the third control command to the mobile terminal that logs in the same server together with the smart TV, and then the server sends the sixth control command to the smart TV that logs in the same server together with the mobile terminal;

Wherein, the preset operation for controlling the play status can be configured as triggering the player of controlling the smart TV to generate the operation corresponding to the preset operation of the play status.

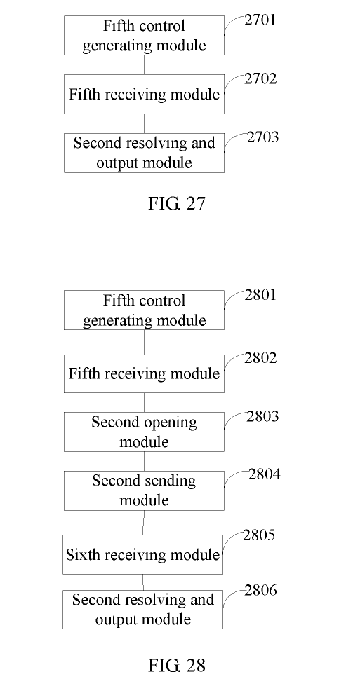

An embodiment of the present disclosure also discloses another data resource transmission device. The device can be applied to a smart TV. Refer to FIG. 27. The device includes: a fifth control generating module 2701, a fifth receiving module 2702 and a second resolving and output module 2703, wherein,

the fifth control generating module 2701 is configured to generate an eighth control command to control the smart TV to log into a preset server;

the fifth receiving module 2702 is configured to receive the third control command sent by the mobile terminal;

wherein, the third control command is a control command generated under the following conditions: the mobile terminal generates the first control command to control the mobile terminal to log into the preset server; when detecting the user's first preset touch operation, the mobile displays the locally stored data resource; when detecting the user's operation of triggering the data resource, the mobile terminal generates the third control command, which carries the triggered data resource and is configured to control the smart TV to output the triggered data resource, and sends the third control command to the server.

The second resolving and output module 2703 is configured to resolve the third control command and output the triggered data resource.

In this embodiment, the smart TV can output the triggered data resource according to the third control command sent by the mobile terminal, meeting people's needs of pushing the local data resource stored on the mobile terminals or network data resource to the smart TV to be output.

Wherein, the fifth receiving module receives the third control command sent by the server in this way: when the mobile terminal generates the control command, which carries the data resource with the sequence mark and is configured to control the smart TV to output the triggered data resource in turn according to the sequence mark, and sends the control command to the server, the resolving and output module is specially set to output the triggered data resource in turn according to the sequence mark.

Wherein, the sequence mark is sequence mark generated by the mobile terminals when determining the output sequence of the triggered data resource and put in the triggered data resource.

An embodiment of the present disclosure also discloses another data transmission device. Refer to FIG. 28. The device may include a fifth receiving module 2801, a fifth receiving module 2802, a second opening module 2803, a second sending module 2804, a sixth receiving module 2805 and a second resolving and output module 2806, wherein,

the fifth control generating module 2801 is configured to generate an eighth control command to control the smart TV to log into a preset server;

the fifth receiving module 2802 is configured to receive the fifth control command sent by the server;

wherein, the fifth control command is a control command generated in the following conditions: the mobile terminal determines the type of the triggered data resource;

when determining that the triggered data resource is video resource or audio resource, the mobile terminal acquires the paths of the triggered data resource, and generates the fifth control command which carries the paths of the triggered data resource and is configured to turn on the player of the smart TV, and sends the fifth control command to the server;

the second opening module 2803 is configured to turn on the player of the smart TV according to the fifth control command.

the second sending module 2804 is configured to send the play request to the server, wherein the server sends the play request to the mobile terminal;

the sixth receiving module 2805 is configured to receive the third control command sent by the sent by the server after the sending module send the play request to the server and the server sends the play request to the mobile terminal; and,

The second resolving and output module 2806 is configured to resolve the third control command and output the triggered data resource.

Wherein, in the present disclosure, the device also includes a fourth receiving module and a second control module, wherein,

the fourth receiving module is configured to receive the sixth control command sent by the server after the resolving and output module resolves the third control command and outputs the triggered data resource;

wherein, the sixth control command is a control command that is generated to be corresponding to the preset operation for controlling the generation of the player of the smart TV and play status, and is sent to the server when the user detects the preset operation for triggering play status.

the control module is configured to control the player of the smart TV to generate the corresponding play status according to the sixth control command.

The specific realization modes of the above devices refer to the corresponding embodiments of the methods in the Description, and therefore are not repeated here.

In the above device, after the mobile terminal and the smart TV log into the same server, when detecting first preset touch operation of the user the mobile terminal displays the locally stored data resource; when detecting user's operation of triggering the data resource, the mobile terminal generates and sends the third control command, which carries the triggered data resource and is configured to the control the smart TV to output the data resource, to the server, then the server sends the third control command to the smart TV; and after receiving the third control command, the smart TV resolves the third control command and outputs the triggered data resource. The present disclosure fulfills the aim of outputting the data resource locally stored in the mobile terminal on the smart TV, meeting peoples' needs pushing the data resource locally stored in the mobile terminal to the smart TV to be output.

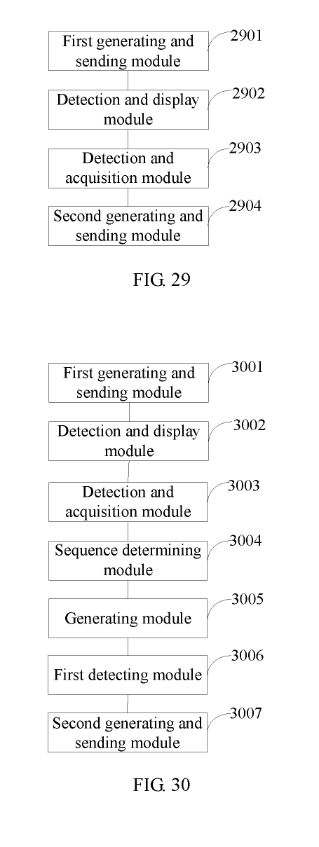

An embodiment of the present disclosure also discloses a transmission device of network data resource. The device can be applied to a mobile terminal. Refer to FIG. 29. The device includes: a first generating and sending module 2901, a detection and display module 2902, a detection and acquisition module 2903 and a second generating and sending module 2904, wherein,

the first generating and sending module 2901 is configured to acquire the IP address of a smart TV, generate and send a first command with the IP address of the smart TV to the smart TV; the first control command controls the mobile terminal and the smart TV to access the same local area network;

the detection and display module 2902 is configured to display a first network browser when detecting a second preset touch operation of a user;

the detection and acquisition module 2903 is configured to acquire the storage address of the triggered network data resource when detecting the user's operation of triggering the network data resource;

the second generating and sending module 2904 is configured to generate and send a second control command, which carries the storage address of the triggered network data resource and is configured to control the smart TV to call a second network browser to output the triggered network data resource according to the storage address of the triggered network data resource, to the smart TV.

In this embodiment, the network data resource stored in the mobile terminal can be output on the smart TV, meeting people's needs of pushing the network data resource stored on the mobile terminals or network data resource to the smart TV to be output.

Optionally, in the present disclosure, the mobile terminal outputs the triggered network data resource through the first network browser. Specifically, the device also includes a first output module;

the first output module is configured to output the triggered network data resource through the first network browser after the detection and acquisition module detects the user's operation of triggering the network data resource and acquiring the storage address of the triggered network data resource.

In this embodiment, the triggered network data resource can be output not only on the mobile terminal, but also on the smart TV, so people can watch the network data resource on different devices, meeting the expanded needs of people.

Optionally, in the present disclosure, the device also includes a fourth detection module, wherein

the fourth detection module is configured to detect a fourth preset touch operation of a user.

The second generating and sending module is specifically set to generate and send a fourth control command, which carries the storage address of the triggered network data resource and is configured to control the smart TV to call a second network browser to output the triggered network data resource according to the storage address of the triggered network data resource, to the smart TV after the fourth detection module detects the fourth preset touch operation of the user.

In order to control the output sequence of the triggered network data resource on the smart TV, an embodiment of the present disclosure also discloses a transmission device of network data resource. As shown in FIG. 30, the device includes: a first generating and sending module 3001, a detection and display module 3002, a detection and acquisition module 3003, a sequence determining module 3004, a generation module 3005, a first detection module 3006 and a second generating and sending module 3007, wherein

the first generating and sending module 3001 is configured to acquire the IP address of a smart TV, generate and send a first command with the IP address of the smart TV to the smart TV; the first control command controls the mobile terminal and the smart TV to access the same local area network;

the detection and display module 3002 is configured to display a first network browser when detecting a second preset touch operation of a user;

the detection and acquisition module 3003 is configured to acquire the storage address of the triggered network data resource when detecting the user's operation of triggering the network data resource;

the sequence determining module 3004 is configured to determine the output sequence of the triggered network data resource;

the generation module 3005 is configured to generate the sequence mark and put the sequence mark in the storage address of the network data resource;

the first detection module 3006 is configured to detect the fourth preset touch operation of the user; and,

the second generating and sending module 3007 is specifically set to generate and send a fourth control command, which carries the storage address of the network data resource with sequence mark and is configured to control the smart TV to call the second network browser to output the network data resource in turn according to the sequence mark and the storage address of the network data resource, to the smart TV after the first detection module detects the fourth preset touch operation of the user.

In this embodiment, the mobile terminal can control the smart TV to output the triggered network data resource in turn according to the corresponding sequence, improving the flexibility of the network data resource output.

Optionally, in the present disclosure, when the triggered network data resource is network video resource or network audio resource, the device also includes:

a third generating and sending module, configured to generate and send a seventh control command corresponding to a preset operation, which controls the generation of the second network browser of the smart TV and the play status, to the smart TV, when detecting that the user triggers the preset operation for controlling the play status on the first network browser.

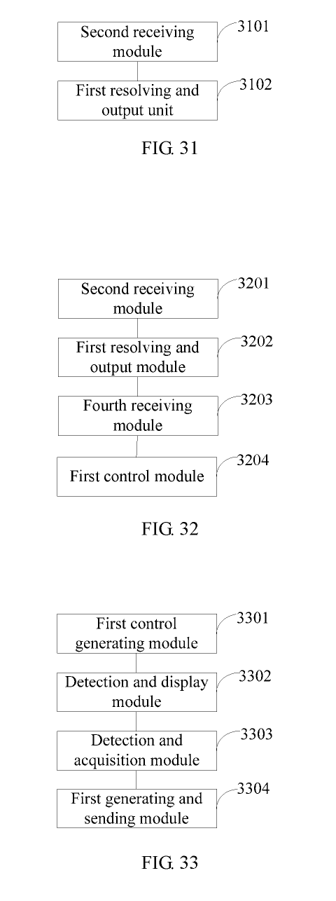

An embodiment of the present disclosure also discloses another transmission device of network data resource. The device can be applied to a smart TV. Refer to FIG. 31. The device includes: a second receiving module 3101 and a first resolving and output module 3102, wherein,

the second receiving module 3101 is configured to receive the fourth control command sent by the mobile terminal;

Wherein, the fourth control command is a control command generated in the following conditions: the mobile terminal acquires the IP address of the smart TV, generates and sends the first control command, which carries the IP address of the smart TV to the smart TV; the first control command controls the mobile terminal and the smart TV to access the same local area network; when detecting the first preset touch operation of the user, the mobile terminal displays the first network browser; when detecting the user's operation of triggering the network data resource, the mobile terminal acquires the storage address of the triggered network data resource and generates the fourth control command, which carries the storage address of the triggered network data resource and is configured to control the smart TV to call the second network browser to output the triggered network data resource according to the storage address of the triggered network data resource.

the first resolving and output module 3102 is configured to resolve the fourth control command and call the second network browser to output the triggered network data resource according to the storage address of the triggered network data resource.

In this embodiment, the smart TV can output the triggered data resource on the second network browser according to the fourth control command sent by the mobile terminal, meeting people's needs of pushing the network data resource stored on the mobile terminal to the smart TV to be output.

Optionally, the first receiving module receives the fourth control command sent by the mobile terminal in the following way: the mobile terminal generates the control command, which carries the storage address of the network data resource with sequence mark, is configured to control the smart TV to call the second network browser to output the triggered network data resource in turn according to the sequence mark and storage address of the triggered network data resource.

Then, the first resolving and output module is specifically set to resolve the fourth control command and call the second network browser to output the triggered network data resource in turn according to the sequence mark and storage address of the triggered network data resource.

Wherein, the sequence mark is sequence mark that is generated by the mobile terminals when determining the output sequence of the triggered network data resource and carried in the storage address of the triggered network data resource.

An embodiment of the present disclosure also discloses another transmission device of network data resource. The device can be applied to a smart TV. The device includes: a first receiving module 3201, and a first resolving and output module 3202, a second receiving module 3203 and a first control module 3204, wherein,

the second receiving module 3201 is configured to receive the fourth control command sent by the mobile terminal;

the first resolving and output module 3202 is configured to resolve the fourth control command and call the second network browser to output the triggered network data resource according to the storage address of the triggered network data resource.

the second receiving module 3203 is configured to receive the seventh control command sent by the mobile terminal;

wherein, the seventh control command is a control command generated to control the second network browser of the smart TV to generate the preset operation corresponding to the play status when the mobile terminal detects that the user triggers the preset operation, which controls the play status, on the first network browser; and

the control module 3204 is configured to control the second network browser of the smart TV to generate the corresponding play status according to the seventh control status.

The specific realization modes of the above devices refer to the corresponding embodiments of the methods in the Description, and therefore are not repeated here.

In the above device, after the mobile terminal and the smart TV establish WIFI connection, the mobile terminal displays the first network browser when detecting the user's first preset touch operation, acquires the storage address of the triggered network data resource, generates and sends the fourth control command, which carries the storage address of the triggered network data resource, is configured to control the smart TV to call the second network browser to output the triggered network data resource according to the storage address of the triggered network data resource, to the smart TV when detecting the user's operation of triggering the network data resource; after receiving the second control command, the smart TV resolves the fourth control command and calls the second network browser to output the triggered network data resource according to the storage address of the triggered network data resource. The present disclosure fulfills the aim of outputting the network data resource in the mobile terminal onto the smart TV, meeting people's needs of pushing the network data resource stored on the mobile terminals or network data resource to the smart TV to be output.

An embodiment of the present disclosure also discloses a transmission device of network data resource. The device can be applied to a mobile terminal. Refer to FIG. 33. The device includes: a first control generating module 3301, a detection and display module 3302, a detection and acquisition module 3303 and a first generating and sending module 3304, wherein,

the first control generating module 3301 is configured to generate a second control command to control the mobile terminal to log into a preset server.

the detection and display module 3302 is configured to display a first network browser when detecting a second preset touch operation of a user;

the detection and acquisition module 3303 is configured to acquire the storage address of the triggered network data resource when detecting the user's operation of triggering the network data resource;

the first sending and sending module 3304 is configured to generate and send the second control command, which carries the storage address of the triggered network data resource and is configured to control the smart TV to call the second network browser to output the triggered network data resource according to the storage address of the triggered network data resource, to the server, wherein the server sends the fourth control command to the smart TV that logs in the same server together with the mobile terminal.

In this embodiment, the network data resource stored in the mobile terminal can be output on the smart TV, meeting people's needs of pushing the network data resource stored on the mobile terminals or network data resource to the smart TV to be output.

Optionally, in the present disclosure, the mobile terminal outputs the triggered network data resource through the first network browser. Specifically, the device also includes a first output module;

the first output module is configured to output the triggered network data resource through the first network browser after the detection and acquisition module detects the user's operation of triggering the network data resource and acquiring the storage address of the triggered network data resource.

In this embodiment, the triggered network data resource can be output not only on the mobile terminal, but also on the smart TV, so people can watch the network data resource on different devices, meeting the expanded needs of people.

Optionally, in the present disclosure, the device also includes a first detection module, wherein

the first detection module is configured to detect a fourth preset touch operation of a user.

The first generating and sending module is specifically configured to generate and send the fourth control command, which carries the storage address of the triggered network data resource and is configured to control the smart TV to call the second network browser and output the triggered network data resource according to the storage address of the triggered network data resource, to the server after the first detection module detects the user's fourth preset touch operation, and the server sends the fourth control command to the smart TV that logs in the same server together with the mobile terminal.

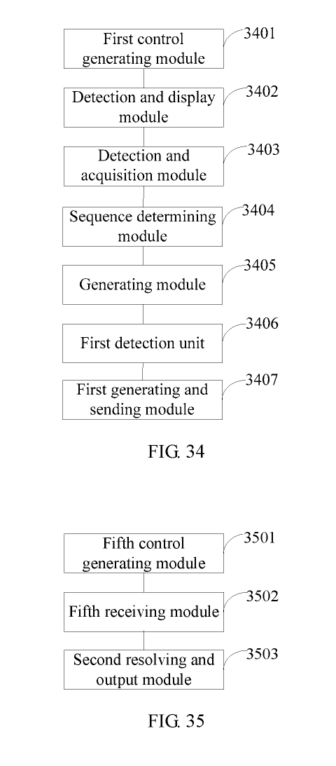

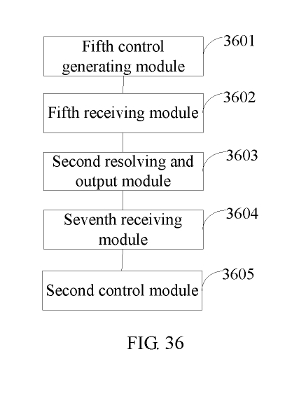

In order to control the output sequence of the triggered network data resource on the smart TV, an embodiment of the present disclosure also discloses a transmission device of network data resource. As shown in FIG. 34, the device includes: a first control generating module 3401, a detection and display module 3402, a detection and acquisition module 3403, a sequence determining module 3404, a generation module 3405, a first detection module 3406 and a first generating and sending module 3407, wherein

the first control generating module 3401 is configured to generate a second control command to control the mobile terminal to log into a preset server.

the detection and display module 3402 is configured to display a first network browser when detecting a second preset touch operation of a user;

the detection and acquisition module 3403 is configured to acquire the storage address of the triggered network data resource when detecting the user's operation of triggering the network data resource;

the sequence determining module 3404 is configured to determine the output sequence of the triggered network data resource;

the generation module 3405 is configured to generate the sequence mark and put the sequence mark in the storage address of the network data resource;

the first detection module 3406 is configured to detect the fourth preset touch operation of the user; and,

the first generating and sending module 3407 is specially configured to generate and send the fourth control command, which carries the storage address of the network data resource with the sequence mark and is configured to control the smart TV to call the second network browser to output the triggered network data resource according to the sequence mark and the storage address of the triggered network data resource, to the server, after the first detection module detects the user's fourth preset touch operation, and the server sends the fourth control command to the smart TV that logs in the same server together with the mobile terminal.

In this embodiment, the mobile terminal can control the smart TV to output the triggered network data resource in turn according to the corresponding sequence, improving the flexibility of the network data resource output.

Optionally, in the present disclosure, when the triggered network data resource is network video resource or network audio resource, the device also includes:

the second generating and sending module, configured to generate and send the seventh control command corresponding to the preset operation, which controls the generation of the second network browser and the play status of the smart TV, to the server when detecting that the user triggers the preset operation, which controls the play status, on the first network browser, wherein the server sends the seventh control command to the smart TV that logs in the same server together with the mobile terminal.

An embodiment of the present disclosure also discloses another transmission device of network data resource. The device can be applied to a smart TV. Refer to FIG. 35. The device includes: a fifth control generating module 3501, a fifth receiving module 3502 and a second resolving and output module 3503, wherein,

the fifth control generating module 3501 is configured to generate an eighth control command to control the smart TV to log into a preset server;

the fifth receiving module 3502 is configured to receive the fourth control command sent by the server;

Wherein, the fourth control command is a control command generated in the following conditions: the mobile terminal generates the first control command to control the mobile terminal to log into the preset serve; when detecting the second preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server.

the second resolving and output module 3503 is configured to resolve the fourth control command and call the second network browser to output the triggered network data resource according to the storage address of the triggered network data resource.

In this embodiment, the smart TV can output the triggered network data resource on the second network browser according to the fourth control command sent by the server, meeting people's needs of pushing the network data resource stored on the mobile terminal to the smart TV to be output.

Optionally, the first receiving module receives the fourth control command sent by the server in the following way: the mobile terminal generates the control command, which carries the storage address of the network data resource with sequence mark, is configured to control the smart TV to call the second network browser to output the triggered network data resource in turn according to the sequence mark and storage address of the triggered network data resource, and is sent to the server.

Then, the second resolving and output module is specifically set to resolve the fourth control command and call the second network browser to output the triggered network data resource in turn according to the sequence mark and storage address of the triggered network data resource.

Wherein, the sequence mark is sequence mark that is generated by the mobile terminals when determining the output sequence of the triggered network data resource and carried in the storage address of the triggered network data resource.

An embodiment of the present disclosure also discloses another transmission device of network data resource. The device can be applied to a smart TV. The device may include: a fifth control generating module 3601, and a fifth receiving module 3602, a second resolving and output module 3603, a seventh receiving module 3604 and a second control module 3605, wherein,

the fifth control generating module 3601 is configured to generate an eighth control command to control the smart TV to log into a preset server;

the fifth receiving module 3602 is configured to receive the fourth control command sent by the server;

the second resolving and output module 3603 is configured to resolve the fourth control command and call the second network browser to output the triggered network data resource according to the storage address of the triggered network data resource.

the seventh receiving module 3604 is configured to receive the seventh control command sent by the server;

wherein, the seventh control command is a control command generated under the following conditions: when detecting that the user triggers the preset operation, which controls the play status, on the first network browser, the mobile terminal generates the seventh control command to control the second network browser of the smart TV to generate the preset operation corresponding to the play status, and sends the seventh control command to the server.

The second control module 3605 is configured to control the second network browser of the smart TV to generate the corresponding play status according to the seventh control status.

The specific realization modes of the above devices refer to the corresponding embodiments of the methods in the Description, and therefore are not repeated here.

In the above device, after the mobile terminal and the smart TV log into the same server, the mobile terminal displays the first network browser when detecting the user's second preset touch operation, acquires the storage address of the triggered network data resource, generates and sends the fourth control command, which carries the storage address of the triggered network data resource, is configured to control the smart TV to call the second network browser to output the triggered network data resource according to the storage address of the triggered network data resource, to the server when detecting the user's operation of triggering the network data resource, and the server sends the fourth control command to the smart TV; after receiving the second control command, the smart TV resolves the fourth control command and calls the second network browser to output the triggered network data resource according to the storage address of the triggered network data resource. The present disclosure fulfills the aim of outputting the network data resource in the mobile terminal onto the smart TV, meeting people's needs of pushing the network data resource stored on the mobile terminals or network data resource to the smart TV to be output.

It should be noted that, the embodiments in the present disclosure are disclosed progressively, each embodiment mainly emphasis the differences from other embodiments, the similar part between different embodiments may be referred to each other. The various device embodiments correspond to the method embodiments, therefore the description is relatively simple, the related parts may be referred to the method embodiments.

The illustration of the embodiment of the present disclosure may allow a skilled person in the art to realize or use the application. The various amendments to the embodiments are apparently to a skilled person in the art. The basic principle defined in the present disclosure may be realized in other embodiments without departure from the spirit or scope of the present disclosure. Thusly, the present disclosure is not limited to be the embodiments of the present disclosure, instead, it conforms to the widest scope which is in accordance with the principle and novelty disclosed in the present disclosure.

1. A data resource transmission method, applied to a mobile terminal, the method comprising:
acquiring an IP address of a smart TV, generating and sending a first command with the IP address of the smart TV to the smart TV, wherein the first control command controls the mobile terminal and the smart TV to access the same local area network; or generating a second control command to control the mobile terminal to log into a preset server;
when detecting a first preset touch operation of a user, displaying locally stored data resource;
when detecting the user's operation of triggering the data resource, generating and sending a third command, which carries the triggered data resource and is configured to control the smart TV to output the triggered data resource, to the smart TV, or sending the third control command to the server such that the server sends the third control command to the smart TV which logs into the same server together with the mobile terminal;
or,
when detecting a second preset touch operation of the user, displaying a first network browser;
when detecting the operation that the user triggers the network data resource, acquiring a storage address of the triggered network data resource;
generating and sending a fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal.

2. The method according to claim 1, characterized by, before generating and sending a third command, which carries the triggered data resource and is configured to control the smart TV to output the triggered data resource, to the smart TV, or before sending the third control command to the server such that the server sends the third control command to the smart TV which logs into the same server together with the mobile terminal, the method further comprising:
determining the sequence of outputting the triggered data resource;
generating a sequence mark and putting the sequence mark in the triggered data resource;
generating a third preset touch operation of the user;
before generating and sending the fourth control command, which carries the storage address of the network data resource and is configured to control the smart TV to call the second network browser to output the network data resource according to the storage address of the network data resource, to the smart TV, or before sending the fourth control command to the server such that the server sends the fourth control command to the smart TV that logs in the same server together with the mobile terminal, the method further comprising:
determining the sequence of outputting the triggered network data resource;
generating sequence mark and putting the sequence mark in the storage address of the triggered data resource;
detecting a fourth preset touch operation of the user;
generating and sending a third command, which carries the triggered data resource and is used to control the smart TV to play the triggered data resource, to the smart TV, or sending the third control command to the server such that the server sends the third control command to the smart TV which logs into the same server together with the mobile terminal, is specifically as follows:
generating and sending a third command, which carries the data resource with the sequence mark and is configured to control the smart TV to output the triggered data resource in turn according to the sequence mark, to the smart TV, or sending the third control command to the server such that the server sends the third control command to the smart TV which logs into the same server together with the mobile terminal;
generating and sending the fourth control command, which carries the storage address of the network data resource and is configured to control the smart TV to call the second network browser to output the network data resource according to the storage address of the network data resource, to the smart TV, or sending the fourth control command to the server such that the server sends the fourth control command to the smart TV that logs in the same server together with the mobile terminal, is specifically as follows:
generating and sending a fourth control command, which carries the storage address of the network data resource with the sequence mark and is configured to control the smart TV to call the second network browser to output the triggered network data resource according to the sequence mark and the storage address of the triggered network data resource, to the smart TV, or sending the fourth control command to the server such that the server sends the fourth control command to the smart TV that logs in the same server together with the mobile terminal.

3. The method according to claim 1, characterized by, before generating and sending a third command, which carries the triggered data resource and is configured to control the smart TV to output the triggered data resource, to the smart TV, or before sending the third control command to the server such that the server sends the third control command to the smart TV which logs into the same server together with the mobile terminal, the method further comprising:
determining the type of outputting the triggered data resource;
when determining that the triggered data resource is the video resource or audio resource, acquiring the path of the triggered resource;
generating and sending a fifth control command, which carries the path of the triggered data resource, to the smart TV, or sending the fifth control command to the server such that the server sends the fifth control command to the smart TV which logs into the same sever together with the mobile terminal, and the fifth control command is configured to turn on the player of the smart TV;
receiving a play request sent by the smart TV after turning on the player or receiving the play request sent by the smart TV after turning on the player through the server.

4. The method according to claim 3, characterized by, after generating and sending a third command, which carries the triggered data resource and is configured to control the smart TV to output the triggered data resource, to the smart TV, or sending the third control command to the server such that the server sends the third control command to the smart TV which logs into the same server together with the mobile terminal, also comprising:
when detecting that the user triggers the preset operation for controlling the play status, generating and sending a sixth control command corresponding to a preset operation which controls the player generation of the smart TV and the play status to the smart TV, or sending the sixth control command to the server such that the server sends the sixth control command to the smart TV which logs into the same server together with the mobile terminal.
when the triggered network data resource is network video resource or network audio resource, after generating and sending a fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal, also comprising:
when detecting that the user triggers the preset operation for controlling the play status on the first network browser, generating and sending a seventh control command corresponding to a preset operation which controls the generation of the second network browser of the smart TV and the play status to the smart TV.

5. A data resource transmission method, applied to a smart TV, the method comprising:
receiving the third control command or fourth control command sent by the mobile terminal, wherein the third control command or fourth control command is the first control command; the mobile terminal acquires the IP address of the smart TV, generates and sends the first control command, which carries the acquired the IP address of the smart TV to the smart TV; the first control command controls the mobile terminal and the smart TV to access the same local area network;
displaying locally stored data resource when detecting the user's first preset touch operation, and generating the a control command, which carries the triggered data resource and is configured to control the smart TV to output the triggered data resource when detecting the user's operation of triggering the data resource;
when detecting a second preset touch operation of the user, displaying the first network browser; when detecting the user's operation of triggering the network data resource, acquiring the storage address of the triggered network data resource, generating the third control command, which carries the storage address of the triggered network data resource and is configured to control the smart TV to call the second network browser to output the triggered network data resource according to the storage address of the triggered network data resource; resolving the third control command, outputting the triggered network data resource; or resolving the fourth control command, and calling the second network browser to output the triggered network data resource according to the storage address of the triggered network data resource.

6. The method according to claim 5, characterized in that, the third control command sent by the mobile terminal is the control command that is generated by the mobile terminal, carries the data resource with the sequence mark and is configured to control the smart TV to output the triggered data resource in turn according to the sequence mark; wherein, the sequence mark is sequence mark that is generated by the mobile terminals when determining the output sequence of the triggered data resource and carried in the triggered data resource;
outputting the data resource specifically is:
outputting the triggered data resource in turn according to the sequence mark;
receiving the fourth control command sent by the mobile terminal is as follows: the mobile terminal generates the control command, which carries the storage address of the network data resource with sequence mark, is configured to control the smart TV to call the second network browser to output the triggered network data resource in turn according to the sequence mark and storage address of the triggered network data resource; wherein the sequence mark is sequence mark that is generated by the mobile terminals when determining the output sequence of the triggered network data resource and carried in the storage address of the triggered network data resource;
resolving the fourth control command and calling the second network browser to output the triggered network data resource according to the storage address of the triggered network data resource is specifically as follows:
resolving the fourth control command and calling the second network browser to output the triggered network data resource according to the sequence mark and the storage address of the triggered network data resource.

7. The method according to claim 5, characterized in that, before receiving the second control command sent by the mobile terminal, also comprising:
receiving a fifth control command sent by the mobile terminal, wherein, the fifth control command is a control command generated in the following conditions: the mobile terminal determines the type of the triggered data; when determining that the triggered data resource is video resource or audio resource, the mobile terminal acquires the paths of the triggered data resource, and generates the fifth control command which carries the paths of the triggered data resource and is configured to turn on the player of the smart TV.
turning on the player of the smart TV according to the fifth control command; and,
sending a play request to the mobile terminal.

8. The method according to claim 7, characterized by after resolving the second control command and outputting the triggered data resource, also comprising:
receiving a sixth control command sent by the mobile terminal, wherein, the sixth control command is a control command corresponding to the preset operation for controlling the generation of player of the smart TV and the play status, generated when the user detects the user's preset operation for controlling the play status;
controlling the player of the smart TV to generate the corresponding play status according to the sixth control command;
after resolving the fourth control command and calling the second network browser to output the network data resource according to the storage address of the triggered network data resource, also comprising:
receiving a seventh control command sent by the mobile terminal, wherein, the seventh control command is a control command generated to control the second network browser of the smart TV to generate the preset operation corresponding to the play status when the mobile terminal detects that the user triggers the preset operation, which controls the play status, on the first network browser; and
controlling the second network browser of the smart TV to generate the corresponding play status according to the seventh control command.

9. A data resource transmission method, applied to a smart TV, the method comprising:
generating an eighth control command to control the mobile terminal to log into a preset server;
receiving the third control command or fourth control command sent by the server, wherein the third control command is a control command generated under the following conditions; the mobile terminal generates the second control command to control the mobile terminal the log into the preset server; when detecting the user's first preset touch operation, the mobile terminal displays locally stored data resource; when detecting the user's operation of triggering the data resource, the mobile terminal generates the control command, which carries the triggered data resource and is configured to control the smart TV to output the triggered data resource, and sends the third control command to the server; wherein, the fourth control command is a control command generated in the following conditions: the mobile terminal generates the first control command to control the mobile terminal to log into the preset server; when detecting the second preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server;
resolving the third control command and outputting the triggered data resource; resolving the fourth control command and calling the second network browser to output the triggered
network data resource according to the storage address of the triggered network data resource.

10. The method according to claim 9, characterized in that, the step of receiving the third control command sent by the server is as follows: the mobile terminal generates a third control command, which carries the data resource with the sequence mark and is configured to control the smart TV to output the triggered data resource in turn according to the sequence mark, and sends the control command to the server; wherein, the sequence mark is generated when the mobile terminal determines the output sequence of the triggered data resource, and carried in the triggered data resource;
receiving the fourth control command sent by the server is as follows: the mobile terminal generates the control command, which carries the storage address of the network data resource with sequence mark and is configured to control the smart TV to call the second network browser to output the triggered network data resource in turn according to the sequence mark and storage address of the triggered network data resource, and sends the fourth control command to the server; wherein the sequence mark is generated when the mobile terminal determines the output sequence of the triggered network data resource, and carried in the storage address of the triggered network data resource;
outputting the triggered data resource is specifically:
outputting the triggered data resource in turn according to the sequence mark;
resolving the fourth control command and calling the second network browser to output the triggered network data resource according to the storage address of the triggered network data resource is specifically as follows:
resolving the second control command and calling the second network browser to output the triggered network data resource according to the sequence mark and the storage address of the triggered network data resource.

11. The method according to claim 10, characterized in that, before receiving the third or fourth control command sent by the server, also comprising:
receiving a fifth control command sent by the server; wherein, the fifth control command is a control command generated in the following conditions: the mobile terminal determines the type of the triggered data resource; when determining that the triggered data resource is video resource or audio resource, the mobile terminal acquires the paths of the triggered data resource, generates the fifth control command, which carries the paths of the triggered data resource and is configured to turn on the player of the smart TV, and sends the fifth control command to the server;
turning on the player of the smart TV according to the fifth control command; and,
sending a play request to the server, wherein the server sends the play request to the mobile terminal.

12. The method according to claim 11, characterized by after resolving the third control command and outputting the triggered data resource, also comprising:
receiving a sixth control command sent by the server, wherein, the sixth control command is a control command generated when the mobile terminal detects that the user triggers the preset operation for controlling the play status; and the sixth control command is a control command corresponding to the preset operation for controlling the generation of the player of the smart TV and play status, and is sent to the server;
controlling the player of the smart TV to generate the corresponding play status according to the sixth control command;
after resolving the fourth control command and calling the second network browser to output the network data resource according to the storage address of the triggered network data resource, also comprising:
receiving a seventh control command sent by the server, wherein, the seventh control command is a control command generated under the following conditions: when detecting that the user triggers the preset operation, which controls the play status, on the first network browser, the mobile terminal generates the seventh control command corresponding to the preset operation which controls the generation of the second browser of the smart TV and the play status, and sends the seventh control command to the server;
controlling the second network browser of the smart TV to generate the corresponding play status according to the seventh control command.

13. A mobile terminal for data resource transmissions, comprising:
at least one first processor;
a first memory for storing at least one instruction executable by the first processor;
wherein the first processor is configured to perform:
acquiring an IP address of a smart TV, generating and send a first command with the IP address of the smart TV to the smart TV, wherein the first control command controls the mobile terminal and the smart TV to access the same local area network; or generate a second control command to control the mobile terminal to log into a preset server;
displaying locally stored data resource when detecting the user's preset touch operation, or displaying the a first network browser when detecting the user's second preset touch operation, and acquire the storage address of the triggered network data resource when detecting the user's operation of triggering the network data resource;
when detecting the user's operation of triggering the data resource, generating and send the third control command, which carries the triggered data resource and is configured to control the smart TV to output the triggered data resource, to the smart TV, or send the third control command to the server such that the server sends the third control command to the smart TV that logs in the same server together with the mobile terminal; or when detecting the user's operation of triggering the network data resource, generating and send the fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal.

14. The mobile terminal according to claim 13, characterized by, the first processor is further configured to perform:
verifying the output sequence of the triggered data resource or the triggered network data resource;
generating the sequence mark and putting the sequence mark in the triggered data resource or storage address of the network data resource;
detecting a third or fourth preset touch operation of a user;
after detecting the user's second preset touch operation, generating and sending, the third control command, which carries the triggered data resource and is configured to control the smart TV to output the triggered data resource, to the smart TV, or sending the third control command to the server such that the server sends the third control command to the smart TV that logs in the same server together with the mobile terminal; or generating and send the fourth control command, which carries the storage address of the triggered network data resource and is configured to control the smart TV to call the second network browser to output the triggered network data resource according to the sequence mark and the storage address of the triggered network data resource, to the smart TV, or sending the fourth control command to the server such that the server sends the fourth control command to the smart TV that logs in the same server together with the mobile terminal.

15. The mobile terminal according to claim 13, characterized by, the first processor is further configured to perform:
verifying the type of outputting the triggered data resource;
acquiring the paths of the triggered data resource when determining the triggered data resource is video resource or audio resource;
generating and sending the fifth control command which carries the path of the triggered data resource, to the smart TV, or sending the fifth control command to the server to send the fifth control command, by the server, to the smart TV that logs in the same sever together with the mobile terminal, wherein the fifth control command is configured to turn on the player of the smart TV;
receiving a play request, or through the server, receiving the play request sent by the smart TV after the smart TV turning on the player;
generating and sending the second control command that carries the triggered data resource and configured set to control the smart TV to output the triggered data resource to the smart TV when receiving the play request after the smart TV turns on the player.

16. The mobile terminal according to claim 15, characterized by, the first processor is further configured to perform:
when defecting the user's preset operation of triggering the play status, generating and send the sixth control command corresponding to the preset operation for controlling the generation of the player of the smart TV and the play status to the smart TV or sending the sixth control command to the smart TV through the server; or when detecting the user triggers the preset operation, which controls on the play status, on the first network browser, generating and sending the seven control command corresponding to the preset operation which controls the generation and play status of the second browser of the smart TV, to the smart TV, or sending the seventh control command to the smart TV through the server.

17. A smart TV for data resource transmission, the smart TV comprising:
at least one second processor;
a second memory for storing at least one instruction executable by the second processor;
wherein the second processor is configured to perform:
receiving the third control command or fourth control command sent by the mobile terminal, wherein the third control command or fourth control command is generated under the following conditions: the mobile terminal acquires the IP address of the smart TV, generates and sends the first control command with the IP address of the smart TV to the smart TV; the first control command controls the mobile terminal and the smart TV to access the same local area network; when detecting the user's first preset touch operation, the mobile terminal displays the locally stored data resource; when detecting the user's operation of triggering the data resource, the mobile terminal generates a control command which carries the triggered data resource and is configured to control the smart TV to output the triggered data resource; when detecting the user's second preset touch operation, the mobile terminal displays the first network browser; when detecting the user's operation of triggering network data resource, the mobile terminal acquires storage address of the triggered network data resource, and generates a control command that carries the storage address of the triggered network data resource, is configured to control the smart TV to call the second network browser to output the triggered network data resource according to the storage address of the triggered network data resource;
resolving the third control command and outputting the triggered data resource, or resolving the fourth control command and calling the second network browser to output the triggered network data resource according to the storage address of the triggered network data resource.

18. The smart TV according to claim 17, characterized in that, receiving the third control command sent by the mobile terminal in this way: the mobile terminal generates a control command that carries the data resource with the sequence mark and is configured to control the smart TV to output the triggered data resource in turn according to the sequence mark; wherein, the sequence mark is generated when the mobile terminal determines the output sequence of the triggered data resource and is carried in the triggered data resource;
receiving the fourth control command sent by the mobile terminal in the following way: the mobile terminal generates a control command which carries the storage address of the network data resource with sequence mark and is configured to control the smart TV to call the second network browser to output the triggered network data resource in turn according to the sequence mark and storage address of the triggered network data resource; wherein the sequence mark is generated when the mobile terminal determines the output sequence of the triggered network data resource and is carried in the storage address of the triggered network data resource; outputting the triggered data resource in turn according to the sequence mark;
calling the second network browser to output the triggered network data resource in turn according to the sequence mark and storage address of the triggered network data resource.

19. The smart TV according to claim 17, characterized by, the second processor is further configured to perform:
receiving a fifth control command sent by the mobile terminal; wherein, the fifth control command is a control command generated in the following conditions: the mobile terminal determines the type of the triggered data; when determining that the triggered data resource is video resource or audio resource, the mobile terminal acquires the paths of the triggered data resource, and generates the fifth control command which carries the paths of the triggered data resource and is configured to turn on the player of the smart TV;
turning on the player of the smart TV according to the fifth control command;
sending the play request to the mobile terminal; and,
receiving third control command sent by the mobile terminal after sending the play request to the mobile terminal.

20. The smart TV according to claim 19, characterized by, the second processor is further configured to perform:
receiving the sixth control command sent by the mobile terminal after resolving the third control command and outputs the triggered data resource, or receiving the seventh control command sent by the mobile terminal after resolving the fourth control command and outputting the triggered network data resource;
wherein, the sixth control command is a control command generated under the following conditions: when detecting that user triggers the preset operation for controlling the play status, the mobile terminal generates the sixth control command corresponding to the preset operation for controlling the player generation and play status of the smart TV;
wherein, the seventh control command is a control command generated under the following conditions: when detecting that the user triggers the preset operation, which controls the play status, on the first network browser, the mobile terminal generates the seventh control command corresponding to the preset operation which controls the generation of the second browser of the smart TV and the play status;
controlling the second network browser of the smart TV to generate the corresponding play status according to the sixth control status, or controlling the second network browser of the smart TV to generate corresponding play status according to the seventh control command.

21. A smart TV for data resource transmission, the smart TV comprising:
at least one third processor;
a third memory for storing at least one instruction executable by the third processor;
wherein the third processor is configured to perform:
generating an eighth control command to control the smart TV to log in a preset server;
receiving, the third control command or fourth control command sent by the server, wherein the third control command is a control command generated under the following conditions: the mobile terminal generates the second control command to control the mobile terminal the log into the preset server; when detecting the user's first preset touch operation, the mobile terminal displays locally stored data resource; when detecting the user's operation of triggering the data resource, the mobile terminal generates the control command, which carries the triggered data resource and is configured to control the smart TV to output the triggered data resource, and sends the third control command to the server; wherein, the fourth control command is a control command generated in the following conditions: the mobile terminal generates the first control command to control the mobile terminal to log into the preset server; when detecting the second preset touch operation of the user, the mobile terminal displays the first network browser; when detecting the user's operation of triggering the network data resource, the mobile terminal acquires the storage address of the triggered network data resource, generates the fourth control command, which carries the storage address of the triggered network data resource and is configured to control the smart TV to call the second network browser to output the triggered network data resource according to the storage address of the triggered network data resource, and sends the fourth control command to the server; and,
resolving the third control command and output the triggered data resource, or resolving, the fourth control command and calling the second network browser to output the triggered network data resource according to the storage address of the triggered network data resource.

22. The smart TV according to claim 21, characterized in that, receiving the third control command sent by the server in the following way: the mobile terminal generates a third control command, which carries the data resource with the sequence mark and is configured to control the smart TV to output the triggered data resource in turn according to the sequence mark, and sends the control command to the server; wherein, the sequence mark is generated when the mobile terminal determines the output sequence of the triggered data resource, and is carried in the triggered data resource;
receiving the fourth control command sent by the server in the following way: the mobile terminal generates the control command, which carries the storage address of the network data resource with sequence mark and is configured to control the smart TV to call the second network browser to output the triggered network data resource in turn according to the sequence mark and storage address of the triggered network data resource, and sends the fourth control command to the server; wherein the sequence mark is generated when the mobile terminal determines the output sequence of the triggered network data resource, and is carried in the storage address of the triggered network data resource;
outputting the triggered data resource in the following way:
outputting the triggered data resource in turn according to the sequence mark;
resolving the fourth control command and calling the second network browser to output the triggered network data resource according to the storage address of the triggered network data resource specifically in the following way:
resolving the second control command and calling the second network browser to output the triggered network data resource according to the sequence mark and the storage address of the triggered network data resource.

23. The smart TV according to claim 22, characterized by, the third processor is further configured to perform:
receiving the fifth control command sent by the server; wherein, the fifth control command is a control command generated in the following conditions: the mobile terminal determines the type of the triggered data resource; when determining that the triggered data resource is video resource or audio resource, the mobile terminal acquires the paths of the triggered data resource, generates the fifth control command, which carries the paths of the triggered data resource and is configured to turn on the player of the smart TV, and sends the fifth control command to the server;
turning on the player of the smart TV according to the fifth control command;
sending the play request to the server, wherein the server sends the play request to the mobile terminal.

24. The smart TV according to claim 23, characterized by, the third processor is further configured to perform:
receiving the sixth control command send by the server and receive the seventh control command sent by the server; wherein, the sixth control command is a control command generated when the mobile terminal detects that the user triggers the preset operation for controlling the play status; and the sixth control command is a control command corresponding to the preset operation for controlling the generation of the player of the smart TV and play status, and is sent to the server; wherein, the seventh control command is a control command generated under the following conditions: when detecting that the user triggers the preset operation, which controls the play status, on the first network browser, the mobile terminal generates the seventh control command corresponding to the preset operation which controls the generation of the second browser of the smart TV and the play status, and sends the seventh control command to the server;
controlling the second network browser of the smart TV to generate the corresponding play status according to the sixth control status, or control the second network browser of the smart TV to generate corresponding play status according to the seventh control command.

25. A non-transitory computer readable recording medium having computer programs stored thereon that, when executed by one or more processors of a mobile terminal, cause the mobile terminal to perform:
acquiring an IP address of a smart TV, generating and sending a first command with the IP address of the smart TV to the smart TV, wherein the first control command controls the mobile terminal and the smart TV to access the same local area network; or generating a second control command to control the mobile terminal to log into a preset server;
when detecting a first preset touch operation of a user, displaying locally stored data resource;
when detecting the user's operation of triggering the data resource, generating and sending a third command, which carries the triggered data resource and is configured to control the smart TV to output the triggered data resource, to the smart TV, or sending the third control command to the server such that the server sends the third control command to the smart TV Which logs into the same server together with the mobile terminal;
or,
when detecting a second preset touch operation of the user, displaying a first network browser;
when detecting the operation that the user triggers the network data resource, acquiring a storage address of the triggered network data resource;
generating and sending a fourth control command, which carries the storage address of the triggered network data resource and is configured to control the smart TV to call the second network browser to output the triggered network data resource according to the storage address of the triggered network data resource, to the smart TV, or sending the fourth control command to the server such that the server sends the fourth control command to the smart TV that logs in the same server together with the mobile terminal.
